(19) United States
(12) Patent Application Publication
(10) Pub. No.: US 2008/0279460 A1
(43) Pub. Date: Nov. 13, 2008

(54) Scene Classification Apparatus and Scene Classification Method

(75) Inventors: Hirokazu KASAHARA, Okaya-shi (JP); Tsuneo KASAI, Azumino-shi (JP); Kaori SATO, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/117,641

(22) Filed: May 8, 2008

(30) Foreign Application Priority Data
May 11, 2007 (JP) 2007-127022

(51) Int. Cl. G06K 9/62

(52) U.S. Cl. 382/224

(57) ABSTRACT

The present invention is provided with: a scene classification apparatus, that includes: a first partial classifier that determines that a classification target image pertains to a first scene, according to an evaluation result indicating that a partial image pertains to the first scene, by carrying out an evaluation as to whether or not the partial image pertains to the first scene, based on a partial characteristic amount indicating a characteristic of the partial image that constitutes a part of the classification target image; and a second partial classifier that determines that the classification target image pertains to a second scene having a characteristic different from that of the first scene, based on the partial characteristic amount, in the case where it is not determined that the classification target image pertains to the first scene with the first partial classifier; wherein the first partial classifier determines that, in the case where it is not determined that the classification target image pertains to the first scene, according to an evaluation result indicating that the partial image pertains to the first scene, the classification target image does not pertain to the second scene.

### CROSS-REFERENCE TO RELATED APPLICATIONS

The present application claims priority upon Japanese Patent Application No. 2007-127022 filed on May 11, 2007, which is herein incorporated by reference.

### BACKGROUND

1. Technical Field

The present invention relates to scene classification apparatuses and scene classification methods.

2. Related Art

Apparatuses have been proposed (see International Publication Pamphlet 2004/30373) that perform classification on a scene pertaining to a classification target image based on a characteristic amount from the classification target image indicating an overall feature of that image, then carry out processing (for example, image quality adjustment processing) appropriate to the scene that has been classified.

With this type of classifier, there is a risk that the accuracy of classification will be reduced in the case where classification target images in which a characteristic of a specific scene is expressed partially in the classification target image. Consequently, in order to increase the accuracy of classification for this kind of classification target image, it is conceivable to carry out classification on the classification target image based on a characteristic amount of a portion of the classification target image. In this case, it is necessary to carry out processing on each portion that constitutes the classification target image, which is a problem in that it is difficult to improve the speed of classification processing.

### SUMMARY

The invention has been devised in light of these issues, and it is an object thereof to improve the speed of scene classification processing more than conventional speeds.

A primary aspect of the invention for achieving this object is a scene classification apparatus, comprising:

a first partial classifier that determines that a classification target image pertains to a first scene, according to an evaluation result indicating that a partial image pertains to the first scene, by carrying out an evaluation as to whether or not the partial image pertains to the first scene, based on a partial characteristic amount indicating a characteristic of the partial image that constitutes a part of the classification target image; and

a second partial classifier that determines that the classification target image pertains to a second scene having a characteristic different from that of the first scene, based on the partial characteristic amount, in the case where it is not determined that the classification target image pertains to the first scene with the first partial classifier;

wherein the first partial classifier determines that, in the case where it is not determined that the classification target image pertains to the first scene, according to an evaluation result indicating that the partial image pertains to the first scene, the classification target image does not pertain to the second scene.

Other features of the invention will become clear through the accompanying drawings and the following description.

### BRIEF DESCRIPTION OF THE DRAWINGS

For a more complete understanding of the invention and the advantages thereof, reference is now made to the following description taken in conjunction with the accompanying drawings wherein:

FIG. 1 is a diagram for describing a multifunction machine and a digital still camera;

FIG. 2A is a diagram for describing a configuration of a printing mechanism provided in the multifunction machine; FIG. 2B is diagram for describing storing sections provided in a memory;

FIG. 3 is block diagram for describing functions achieved by a printer-side controller;

FIG. 4 is diagram for describing an overall configuration of a scene classifier;

FIG. 5 is diagram for describing a specific configuration of a scene classifier;

FIG. 6 is a flowchart for describing obtaining partial characteristic amounts;

FIG. 7 is a diagram for describing partial images;

FIG. 8 is a diagram for describing a linear support vector machine;

FIG. 9 is a diagram for describing a nonlinear support vector machine;

FIG. 10 is a diagram showing precision and recall characteristics in a sunset scene partial sub classifier;

FIG. 11 is a diagram showing precision and recall characteristics in a flower partial sub classifier;

FIG. 12 is a diagram showing a single example of actual scenes and classification results;

FIG. 13 is a diagram for describing a method for calculating existence probability and partial precision;

FIG. 14A is a diagram showing existence probabilities of a sunset scene; FIG. 14B is a diagram showing partial precision in a sunset scene; FIG. 14C is a diagram showing multiplication value information of a sunset scene; FIG. 14D is a diagram showing multiplication value ranking information of a sunset scene;

FIG. 15A is a diagram showing existence probabilities of a flower scene; FIG. 15B is a diagram showing partial precision in a flower scene; FIG. 15C is a diagram showing multiplication value information of a flower scene; FIG. 15D is a diagram showing multiplication value ranking information of a flower scene;

FIG. 16A is a diagram showing existence probabilities of an autumnal foliage scene; FIG. 16B is a diagram showing partial precision in an autumnal foliage scene; FIG. 16C is a diagram showing multiplication value information of an autumnal foliage scene; FIG. 16D is a diagram showing multiplication value ranking information of an autumnal foliage scene;

FIG. 17 is a flowchart for describing a method of selecting the number of evaluations of partial images;

FIG. 18 is a diagram showing variation in a maximum value of an F value with respect to the number of evaluations in a sunset scene;

FIG. 19 is a diagram showing variation in a maximum value of the F value with respect to the number of evaluations in a flower scene;

FIG. 20 is diagram for describing positive thresholds and negative thresholds;

FIG. 21 is a diagram showing a relationship between detected image numbers and erroneous determination rates of the sunset scene partial sub classifier;

FIG. 22 is a diagram showing a relationship between detected image numbers and erroneous determination rates of the flower partial sub classifier;

FIG. 23 is a diagram showing a relationship between detected image numbers and erroneous determination rates of the autumnal foliage partial sub classifier;

FIG. 24 is a flowchart for describing an image classification process; and

FIG. 25 is a flowchart for describing a partial image classification process.

### DESCRIPTION OF EXEMPLARY EMBODIMENTS

At least the following matters will be made clear by the description in the present specification and the description of the accompanying drawings.

Namely, it will be made clear that a scene classification apparatus can be achieved that comprises: a first partial classifier that determines that a classification target image pertains to a first scene, according to an evaluation result indicating that a partial image pertains to the first scene, by carrying out an evaluation as to whether or not the partial image pertains to the first scene, based on a partial characteristic amount indicating a characteristic of the partial image that constitutes a part of the classification target image; and a second partial classifier that determines that the classification target image pertains to a second scene having a characteristic different from that of the first scene, based on the partial characteristic amount, in the case where it is not determined that the classification target image pertains to the first scene with the first partial classifier; wherein the first partial classifier determines that, in the case where it is not determined that the classification target image pertains to the first scene, according to an evaluation result indicating that the partial image pertains to the first scene, the classification target image does not pertain to the second scene.

With this scene classification apparatus, according to evaluation results of classification processing with the first partial classifier, the classification processing with the second partial classifier can be omitted. Thus, in the case where processing such as evaluating is performed for each section in the classification target image, unnecessary processing does not have to be carried out. As a result, the speed of classification processing of a scene can be improved.

In this scene classification apparatus, it is preferable that the first partial classifier determines that, in the case where an evaluation value, obtained by evaluating whether or not the partial image pertains to the first scene, exceeds a positive threshold, the classification target image pertains to the first scene.

With this scene classification apparatus, the accuracy of classification in respect to the first scene can be adjusted according to a value of the positive threshold.

In this scene classification apparatus, it is preferable that the positive threshold is provided for each scene corresponding to each partial classifier.

With this scene classification apparatus, classification processing can be carried out that is suited to the scenes respectively.

In this scene classification apparatus, it is preferable that the first partial classifier determines that, in the case where the evaluation value exceeds a negative threshold different from the positive threshold, the classification target image does not pertain to the second scene.

With this scene classification apparatus, according to a value of the negative threshold, the accuracy of determining that the classification target image does not pertain to the second scene can be adjusted.

In this scene classification apparatus, it is preferable that the negative threshold is provided based on an erroneous determination rate that is a probability that the classification target image pertaining to the second scene is mistakenly determined as not pertaining to the second scene with the first partial classifier.

With this scene classification apparatus, in the case where the possibility that the classification target image pertains to the second scene is low, classification processing of a corresponding second partial classifier can be definitely omitted.

In this scene classification apparatus, it is preferable that the negative threshold is provided for each scene that is a classification target other than scenes corresponding to each partial classifier. With this scene classification apparatus, according to an evaluation result of classification processing with each partial classifier, determining of a scene that the classification target image does not pertain to can be efficiently carried out.

In this scene classification apparatus, it is preferable that the evaluation value is the number of the partial images for each of which an evaluation result, indicating that the partial image pertains to the first scene has been obtained.

With this scene classification apparatus, classification can be performed accurately.

In this scene classification apparatus, it is preferable that the first partial classifier determines that the classification target image pertains to the first scene and that the classification target image does not pertain to the second scene, by using an evaluation result of only a predetermined number of the partial images selected from a part of the plurality of partial images that constitute the classification target image.

With this scene classification apparatus, the speed of the classification processing can be further improved.

In this scene classification apparatus, it is preferable that the predetermined number is determined based on a precision that is a probability that, in the case where it has been determined that the classification target image pertains to the first scene with the first partial classifier, the determination thereof is correct, and a recall that is a probability that the classification target image pertaining to the first scene is to be determined with the first partial classifier to pertain to the first scene.

With this scene classification apparatus, as the number of partial images which are to be evaluated, an appropriate value harmonized with precision and speed of classification processing can be determined.

In this scene classification apparatus, it is preferable that the predetermined number of the partial images has been selected based on at least one of an existence probability that is a probability that a characteristic of the first scene is expressed in a partial area corresponding to the partial image, and a partial precision that is a probability that, in the case where an evaluation result indicating that the partial image pertains to the first scene has been obtained, the evaluation result thereof is correct.

With this scene classification apparatus, rather than selecting partial images randomly, a probability that evaluation results indicating that it pertains to the first scene can be increased, so that evaluation can be made efficient.

Furthermore, it will be made clear that a following scene classification method can be achieved.

Namely, it will be made clear that a scene classification method can be achieved, including: determining that a classification target image pertains to a first scene, according to an evaluation result indicating that a partial image pertains to the first scene, by carrying out an evaluation as to whether or not the partial image pertains to the first scene, based on a partial characteristic amount indicating a characteristic of the partial image that constitutes a part of the classification target image; and determining that the classification target image does not pertain to the second scene, according to an evaluation result indicating that the partial image pertains to the first scene, before a determination, in the case where it is not determined that the classification target image pertains to the first scene, as to whether or not the classification target image pertains to a second scene having a characteristic different from that of the first scene, the determination being performed according to an evaluation result indicating that the partial image pertains to the second scene.

In this scene classification method, it is preferable that a scene classification method according to claim 11, comprises: detecting the number of the partial images for each of which an evaluation result, indicating that the partial image pertains to the first scene, has been obtained; determining that the classification target image pertains to the first scene, in the case where the number of the partial images for each of which an evaluation result, indicating that the partial image pertains to the first scene, has been obtained has exceeded a predetermined threshold; and determining that the classification target image does not pertain to the second scene, in the case where the number of the partial images for each of which an evaluation result indicating that the partial image pertains to the first scene has been obtained exceeds a negative threshold different from the positive threshold.

This scene classification method preferably includes: obtaining, using a plurality of sample images, an erroneous determination rate that is a probability that a classification target image pertaining to the second scene is to be determined as not pertaining to the second scene with the first partial classifier, for each of the number of the partial images for each of which an evaluation result, indicating that the partial image pertains to the first scene, has been obtained; and providing the negative threshold based on the erroneous determination rate.

According to such a scene classification method, by obtaining the erroneous determination rate using a plurality of sample images with different compositions, a more accurate erroneous determination rate can be obtained, thus an appropriate negative threshold can be obtained.

### First Embodiment

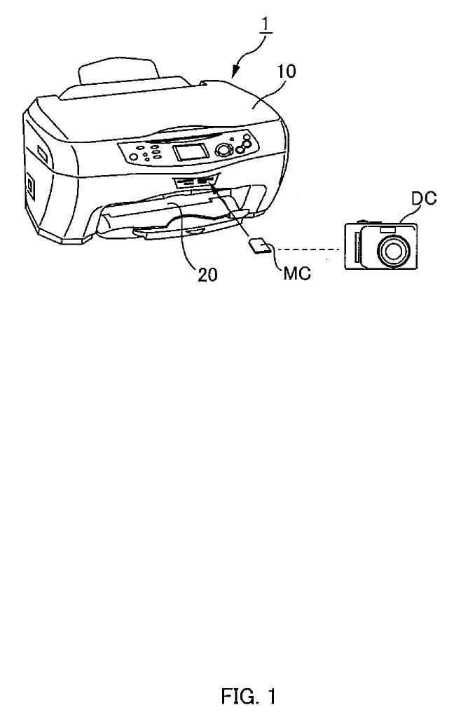

Hereinafter, description is given regarding embodiments of the invention. It should be noted that in the following description, a multifunction machine 1 shown in FIG. 1 is put forth as an example. The multifunction machine 1 is provided with an image reading section 10 that obtains image data by reading an image that has been printed on a medium, and an image printing section 20 that prints an image onto the medium based on the image data. For example, the image printing section 20 prints images onto media based on image data captured by a digital still camera DC and image data obtained by the image reading section 10. Additionally, in the multifunction machine 1, scene classification is carried out on an image to be classified, so that correction may be performed on the image data in accordance with a classification result and the corrected image data may be stored in an external memory such as a memory card MC. Here, the multifunction machine 1 functions as a scene classification apparatus that classifies a scene of an unknown image to be classified. Furthermore, the multifunction machine 1 also functions as a data correction apparatus that corrects image data based on a scene that has been classified, and a data storage apparatus that stores corrected image data in an external memory.

Configuration of the Multifunction Machine 1

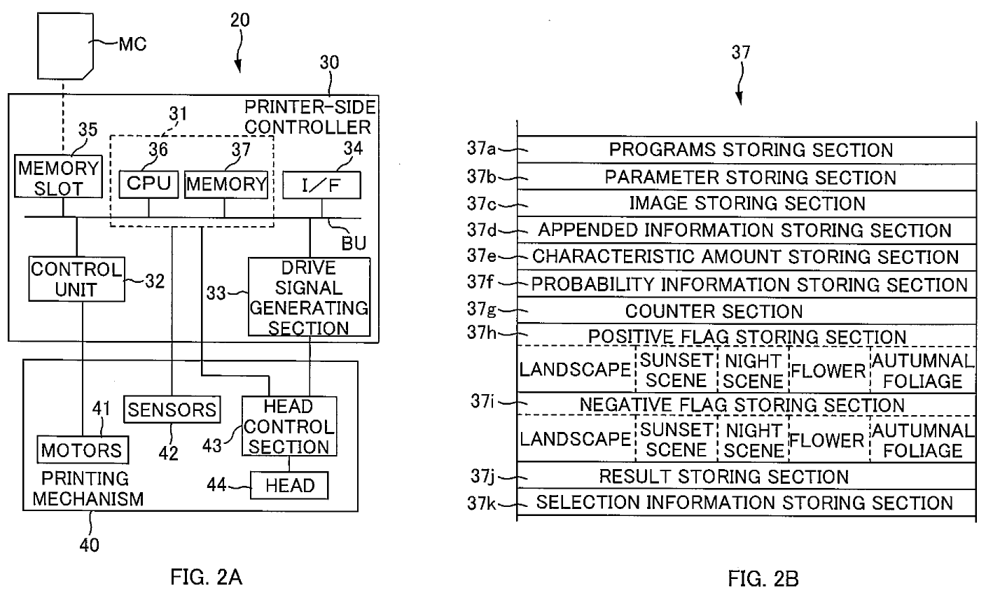

As shown in FIG. 2A, the image printing section 20 is provided with a printer-side controller 30 and a printing mechanism 40.

The printer-side controller 30 is a section that carries out control relating to printing such as control of the printing mechanism 40. The printer-side controller 30 illustrated in FIG. 2A is provided with a main controller 31, a control unit 32, a drive signal generating section 33, and interface 34, and a memory slot 35. And these sections are communicably connected via a bus BU.

The main controller 31 is a section that is centrally involved in performing control, and is provided with a CPU 36 and a memory 37. The CPU 36 functions as a central processing unit, and performs various control operations in accordance with an operation program stored in the memory 37. Accordingly, the operation program is provided with code for realizing the control operations. Furthermore, various information is stored in the memory 37. For example, as shown in FIG. 2B, arranged in portions of the memory 37 are: a program storing section 37a that stores operation programs, a parameter storing section 37b that stores control parameters including a threshold (to be described later) used in a classification process, an image storing section 37c that stores image data, an appended information storing section 37d that stores Exif appended information, a characteristic amount storing section 37e that stores characteristic amounts, a probability information storing section 37f that stores probability information, a counter section 37g that functions as a counter for counting, a positive flag storing section 37h that stores positive flags, a negative flag storing section 37i that stores negative flags, a result storing section 37j that stores classification results, and a selection information storing section 37k, which is described later and in which is stored selection information (multiplication value information or multiplication value ranking information, which are described later) for determining a sequence by which partial images are to be selected in a partial image classification process. It should be noted that each of the sections constituting the main controller 31 are described later.

The control unit 32 for example controls a motor 41 that is arranged in the printing mechanism 40. The drive signal generating section 33 generates drive signals that are applied to drive elements (not shown in diagram) provided in the head 44. The interface 34 is for connecting to higher level apparatuses such as personal computers. The memory slot 35 is a portion for mounting the memory card MC. When the memory card MC is mounted in the memory slot 35, the memory card MC and the main controller 31 are communicably connected. In accordance with this, the main controller 31 can read out information stored on the memory card MC and cause information to be stored on the memory card MC. For example, it can read out image data that has been generated by shooting with the digital still camera DC and can cause corrected image data to be stored after processing such as correction has been executed.

The printing mechanism 40 is a portion that carries out printing on a medium such as paper. The illustrated printing mechanism 40 is provided with a motor 41, a sensor 42, and head control section 43, and a head 44. The motor 41 operates based on control signals from the control unit 32. Examples of the motor 41 include a transport motor for transporting the medium and a movement motor for causing the head 44 to move (neither shown in diagram). The sensor 42 is for detecting conditions in the printing mechanism 40. Examples of the sensor 42 include a media detection sensor for detecting the presence or absence of media and a transport sensor for the media (neither shown in diagram). The head control section 43 is for controlling application of the drive signals to the drive elements in the head 44. In this image printing section 20, the main controller 31 generates head control signals in accordance with image data targeted for printing. And the generated head control signals are sent to the head control section 43. The head control section 43 controls application of the drive signals based on the head control signals that are received. The head 44 is provided with a plurality of drive elements that perform an operation for ejecting ink. Necessary portions of these drive signals that pass through the head control section 43 are applied to these drive elements. Then, the drive elements perform operations for ejecting ink in accordance with the necessary portions that have been applied. In this manner, ink that is ejected lands on the medium and an image is printed on the medium.

Configuration of Sections Achieved by Printer-Side Controller 30

Next, description is given concerning the sections achieved by the printer-side controller 30. The CPU 36 of the printer-side controller 30 performs different operations for each of the plurality of operation modules (program units) that constitute the operation program. Here, the main controller 31, which is provided with the CPU 36 and the memory 37, performs a different function for each operation module either by itself or in combination with the control unit 32 or the drive signal generating section 33. For convenience, in the following description the printer-side controller 30 is represented as the device for each of the operation modules.

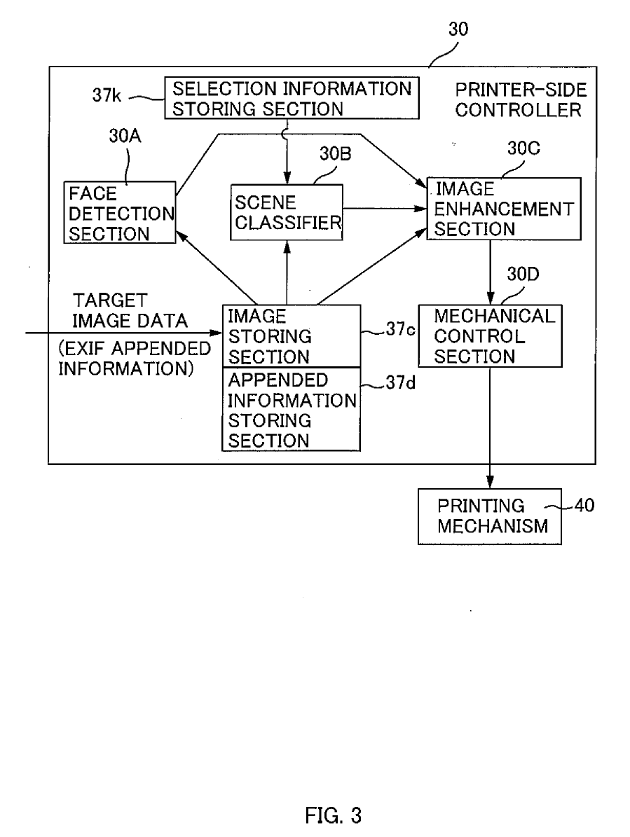

As shown in FIG. 3, the printer-side controller 30 is provided with the image storing section 37c, the appended information storing section 37d, the selection information storing section 37k, a face detection section 30A, a scene classifier 30B, an image enhancement section 30C, and a mechanical control section 30D. The image storing section 37c stores image data targeted for such processing as scene classification processing and correction processing. The image data is one type of classification target data targeted for classification (hereinafter referred to as target image data). The target image data in the present embodiment is constituted by RGB image data. This RGB image data is one type of image data constituted by a plurality of pixels having color information. The appended information storing section 37d stores Exif appended information that is attached to the image data. The selection information storing section 37k stores selection information for determining a sequence by which partial images are to be selected when carrying out evaluations on each partial image in which the classification target image is divided into a plurality of areas. The face detection section 30A performs classification on the target image data for the presence/absence of a portrait face image and a corresponding scene. For example, the face detection section 30A determines a presence/absence of a portrait face image for data of a QVGA (320×240 pixels=76,800 pixels) size. Then, in a case where a face image has been detected, it sorts the classification target image into a portrait scene or a commemorative photo scene (to be described later) based on a total area of the face image. The scene classifier 30B performs classification on scenes pertaining to classification target images for which the face detection section 30A did not determine a scene. The image enhancement section 30C carries out enhancement in accordance with scenes pertaining to the classification target image based on classification results of the face detection section 30A and the scene classifier 30B. The mechanical control section 30D controls the printing mechanism 40 based on the target image data. Here, in a case where correction has been performed on the target image data by the image enhancement section 30C, the mechanical control section 30D controls the printing mechanism 40 based on the corrected image data. In regard to these sections, the face detection section 30A, the scene classifier 30B, and the image enhancement section 30C are configured by the main controller 31. The mechanical control section 30D is configured by the main controller 31, the control unit 32, and the drive signal generating section 33.

Configuration of the Scene Classifier 30B

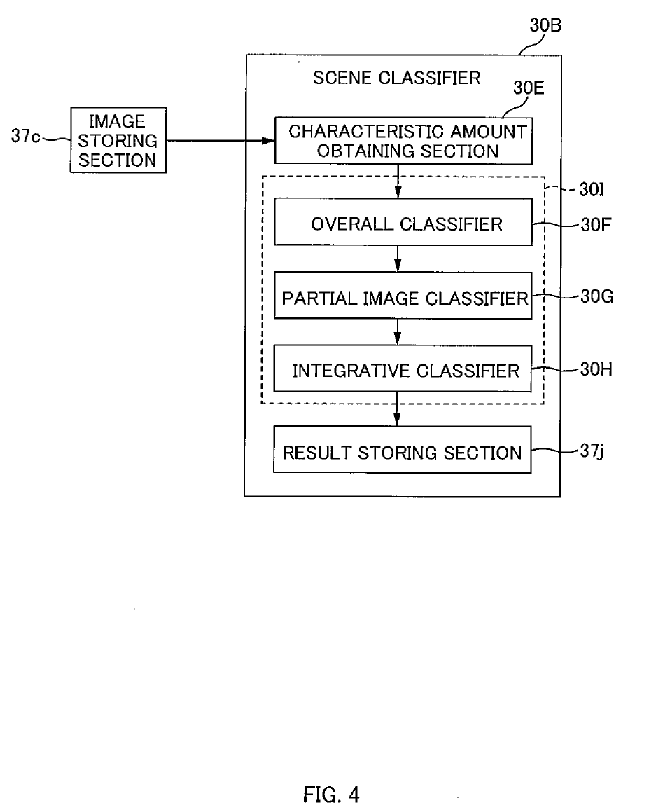

Next, description is given regarding the scene classifier 30B. The scene classifier 30B according to the present embodiment performs classification on classification target images for which no scene was determined by the face detection section 30A as to whether it pertains to a landscape scene, a sunset scene, a night scene, a flower scene, an autumnal foliage scene, or other scene. As shown in FIG. 4, the scene classifier 30B is provided with a characteristic amount obtaining section 30E, an overall classifier 30F, a partial image classifier 30G, an integrative classifier 30H, and the result storing section 37j. Of these, the characteristic amount obtaining section 30E, the overall classifier 30F, the partial image classifier 30G, and the integrative classifier 30H are configured by the main controller 31. And the overall classifier 30F, the partial image classifier 30G, and the integrative classifier 30H constitute a classification processing section 30I that carries out classification processing of a scene pertaining to the classification target image based on at least one of a partial characteristic amount and an overall characteristic amount.

Regarding the Characteristic Amount Obtaining Section 30E

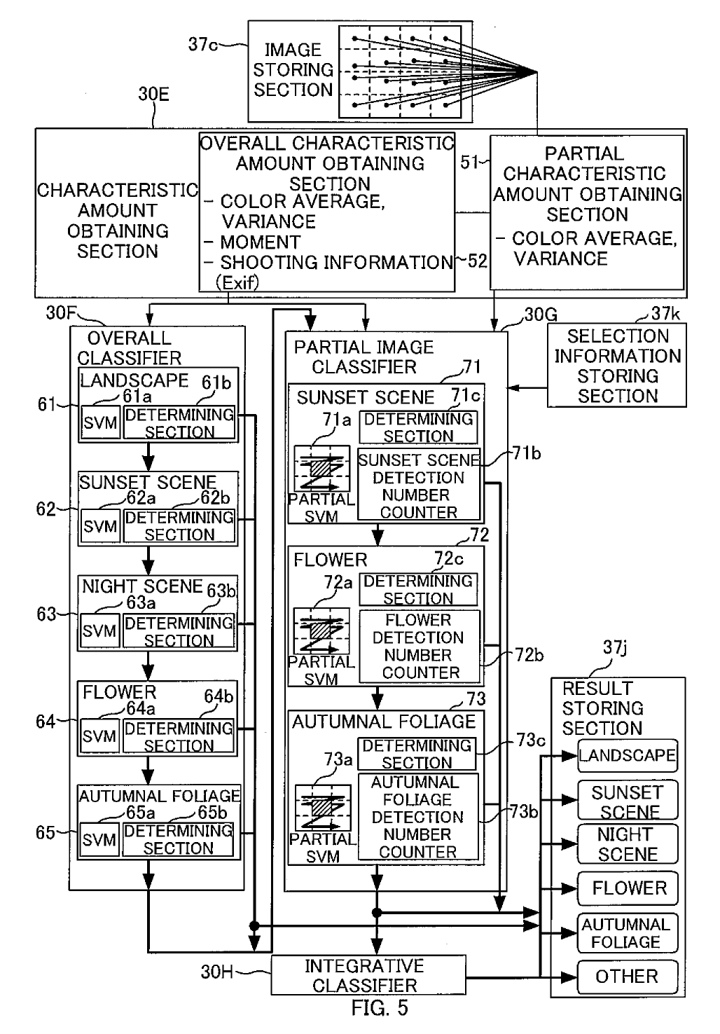

Based on the target image data, the characteristic amount obtaining section 30E obtains a characteristic amount that indicates a feature of the classification target image. The characteristic amount is used in classification by the overall classifier 30F and the partial image classifier 30G. As shown in FIG. 5, the characteristic amount obtaining section 30E is provided with a partial characteristic amount obtaining section 51 and an overall characteristic amount obtaining section 52.

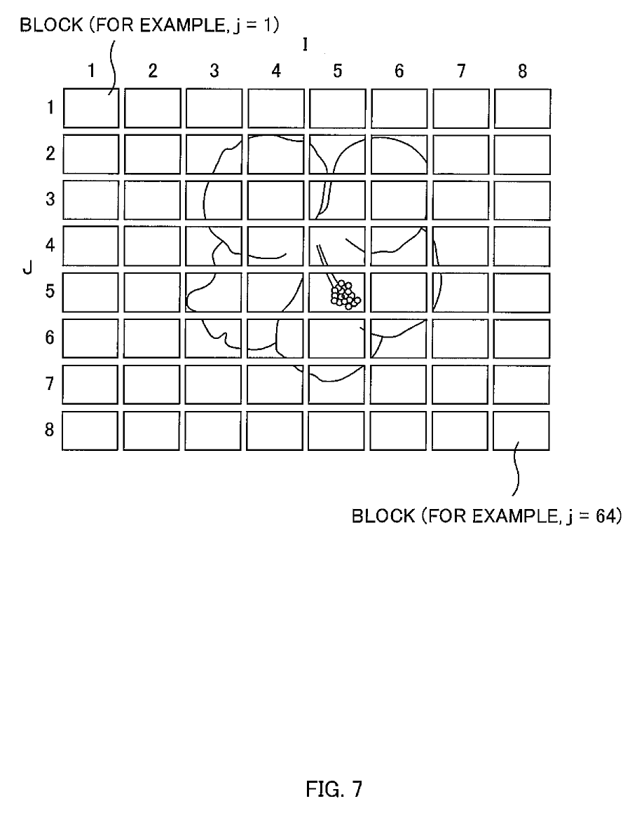

The partial characteristic amount obtaining section 51 obtains partial characteristic amounts for sets of partial image data respectively obtained by dividing the target image data (overall image). That is, the partial characteristic amount obtaining section 51 obtains, as partial image data, data of a plurality of pixels contained in a plurality of partial areas into which an overall area of the image has been divided. It should be noted that the overall area of the image signifies a range in which pixels of the target image data are formed. And the partial characteristic amount obtaining section 51 obtains a partial characteristic amount that indicates a characteristic of the partial image data that has been obtained. Accordingly, the partial characteristic amount indicates a characteristic regarding the partial image corresponding to the partial image data. Specifically, characteristic amounts are indicated for partial images corresponding to a range in which the target image data has been divided equally into 8 sections vertically and horizontally as shown in FIG. 7, that is, partial images of a 1/64 size obtained by dividing the target image data into a grid shape. It should be noted that the target image data in the present embodiment is data of a QVGA size. For this reason, the data of the partial images is data of a 1/64 size thereof (40×30 pixels=1,200 pixels).

Then, the partial characteristic amount obtaining section 51 obtains a color average and a color variance of the pixels constituting the data of the partial image as the partial characteristic amount indicating a characteristic of the partial image. The color of each pixel can be expressed numerically in a color space such as YCC and HSV or the like. Thus, the color average can be obtained by averaging the numerical values. And the color variance indicates an extent of a spread from the average value in the colors of the pixels.

The overall characteristic amount obtaining section 52 obtains an overall characteristic amount based on the target image data. The overall characteristic amount indicates an overall characteristic in the classification target. Examples of the overall characteristic amount include a color average, a color variance, and a moment of the pixels constituting the target image data. The moment is a characteristic amount indicating a distribution (centroid) of the colors. Conventionally, moment is a characteristic amount obtained directly from the target image data. However, with the overall characteristic amount obtaining section 52 according to the present embodiment, these characteristic amounts are obtained using partial characteristic amounts (this is described later). Furthermore, in a case where the target image data is data that has been generated by shooting with the digital still camera DC, the overall characteristic amount obtaining section 52 also obtains Exif appended information from the appended information storing section 37d as an overall characteristic amount. For example, it also obtains shooting information as an overall characteristic amount, such as aperture information indicating aperture, shutter speed information indicating shutter speed, and strobe information indicating on/off of a strobe.

Regarding Obtaining Characteristic Amounts

Next, description is given regarding obtaining characteristic amounts. In the multifunction machine 1 according to the present embodiment, the partial characteristic amount obtaining section 51 obtains a partial characteristic amount for each set of partial image data, then stores the obtained partial characteristic amounts in the characteristic amount storing section 37e of the memory 37. The overall characteristic amount obtaining section 52 reads out the plurality of partial characteristic amounts that are stored in the characteristic amount storing section 37e and obtains an overall characteristic amount. Then the obtained overall characteristic amount is stored in the characteristic amount storing section 37e. By using this configuration, the number of times of conversion or the like performed on the target image data can be kept down and it is possible to achieve higher speed processing compared to a configuration in which partial characteristic amounts and an overall characteristic amount are obtained. Furthermore, the capacity of memory for decompression can be kept to a required minimum.

Regarding Obtaining Partial Characteristic Amounts

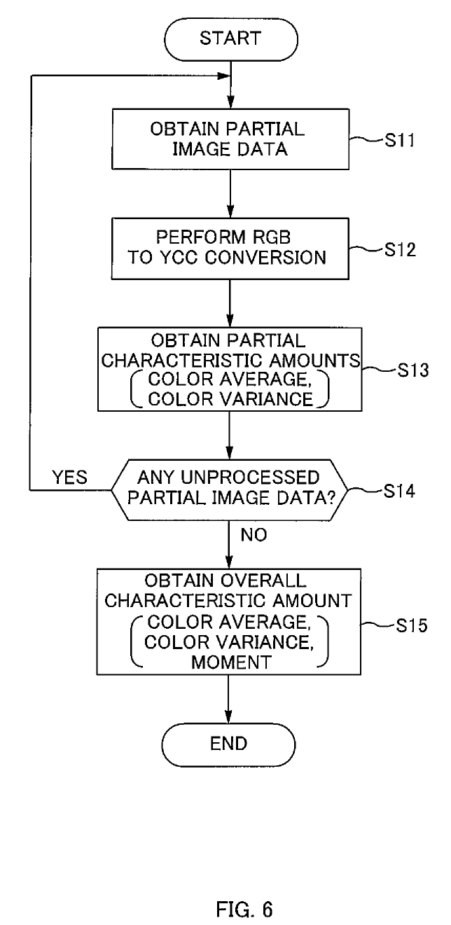

Next, description is given regarding obtaining partial characteristic amounts using the partial characteristic amount obtaining section 51. As shown in FIG. 6, the partial characteristic amount obtaining section 51 first reads out partial image data that constitutes a portion of the target image data from the image storing section 37c of the memory 37 (S11). In the present embodiment, the partial characteristic amount obtaining section 51 obtains RGB image data having a 1/64 size of the QVGA size as the partial image data. It should be noted that in a case where the target image data is image data that has been compressed in a JPEG format or the like, the partial characteristic amount obtaining section 51 reads out the single portion of data that constitutes the target image data from the image storing section 37c and obtains the partial image data by decompressing the data that has been read out. Once the partial image data has been obtained, the partial characteristic amount obtaining section 51 carries out color space conversion (S12). For example, it converts the RGB image data to a YCC image.

Next, the partial characteristic amount obtaining section 51 obtains a partial characteristic amount from the partial image data that has been read out (S13). In the present embodiment, the partial characteristic amount obtaining section 51 obtains a color average and a color variance of the partial image data as the partial characteristic amounts. For convenience, the color average in the partial image data is also referred to as a partial color average. Also, for convenience, the color variance in the partial image data is also referred to as a partial color variance. As shown in FIG. 7, when the classification target image is divided into partial images of 64 blocks and an arbitrary order has been provided for the partial images respectively, color information (a numerical value expressed in a YCC color space for example) of an i^{th} (i=1 to 76,800) pixel in data of a j^{th} (j=1 to 64) partial image is given as xᵢ. In this case, a partial color average xₐᵥⱼ in the j^{th} partial image data can be expressed by the following formula (1).

$${x}_{avj} = \frac{1}{n} {\sum }_{i = 1}^{n} {x}_{i} \qquad ( 1 )$$

Furthermore, a variance S² according to the present embodiment is used that is defined by the following formula (2). For this reason, a partial color variance Sⱼ² in the j^{th} partial image data can be expressed by the following formula (3), which is obtained by transforming formula (2).

$$\begin{matrix}{S}^{2} = \frac{1}{n - 1} {\sum }_{i} {( {x}_{i} - {x}_{av} )}^{2} & ( 2 ) \\ {S}_{j}^{2} = \frac{1}{n - 1} ( {\sum }_{i} {x}_{ij}^{2} - {nx}_{avj}^{2} ) & ( 3 )\end{matrix}$$

Accordingly, by carrying out the operations of formula (1) and formula (3), the partial characteristic amount obtaining section 51 obtains the partial color average xₐᵥⱼ and the partial color variance Sⱼ² for the corresponding partial image data. Then, these partial color averages xₐᵥⱼ and partial color variances Sⱼ² are stored respectively in the characteristic amount storing section 37e of the memory 37.

Once the partial color averages xₐᵥⱼ and partial color variances Sⱼ² have been obtained, the partial characteristic amount obtaining section 51 determines whether or not there is any unprocessed partial image data (S14). In a case where it is determined that there is unprocessed partial image data, the partial characteristic amount obtaining section 51 returns to step S11 and carries out the same processing (S11 to S13) for a next set of partial image data. On the other hand, in a case where it is determined at S14 that there is no unprocessed partial image data, processing by the partial characteristic amount obtaining section 51 finishes. In this case, an overall characteristic amount is obtained by the overall characteristic amount obtaining section 52 at step S15.

Regarding Obtaining Overall Characteristic Amounts

Next, description is given regarding obtaining overall characteristic amounts using the overall characteristic amount obtaining section 52 (SIS). The overall characteristic amount obtaining section 52 obtains an overall characteristic amount based on the plurality of partial characteristic amounts that are stored in the characteristic amount storing section 37e. As mentioned earlier, the overall characteristic amount obtaining section 52 obtains a color average and a color variance of the target image data as the overall characteristic amounts. For convenience, the color average in the target image data is also referred to as an overall color average. Also, for convenience, the variance in color in the target image data is also referred to as an overall color variance. Then, when the partial color average in the aforementioned j^{th} (j=1 to 64) partial image data is set to xₐᵥⱼ, an overall color average xₐᵥ can be expressed by the following formula (4). In formula (4), m indicates a number of partial images. Furthermore, an overall color variance S2 can be expressed by the following formula (5). Using formula (5), it is evident the overall color variance S2 can be obtained based on the partial color average xₐᵥⱼ, the partial color variance Sⱼ², and the overall color average xₐᵥ.

$$\begin{matrix}{x}_{av} = \frac{1}{m} {\sum }_{j} {x}_{avj} & ( 4 ) \\ \begin{matrix}{S}^{2} = \frac{1}{N - 1} ( {\sum }_{j = 1}^{m} {x}_{ji}^{2} - {Nx}_{av}^{2} ) \\ = \frac{1}{N - 1} ( ( n - 1 ) {\sum }_{j = 1}^{m} {S}_{j}^{2} + n {\sum }_{j = 1}^{m} {x}_{avj}^{2} - {Nx}_{av}^{2} )\end{matrix} & ( 5 )\end{matrix}$$

Accordingly, by carrying out the operations of formula (4) and formula (5), the overall characteristic amount obtaining section 52 obtains the overall color average xₐᵥ and the partial color variance S2 for the target image data. Then, the overall color average xₐᵥ and the overall color variances S2 are stored respectively in the characteristic amount storing section 37e of the memory 37.

Furthermore, the overall characteristic amount obtaining section 52 obtains a moment as another overall characteristic amount. In the present embodiment, the classification target is an image and therefore a positional distribution of color can be obtained quantitatively using a moment. In the present embodiment, the overall characteristic amount obtaining section 52 obtains the moment based on the color average xₐᵥⱼ of each set of partial image data. Here, partial images specified by a vertical position J (J=1 to 8) and horizontal position I (I=1 to 8) in the 64 partial images shown in FIG. 7 are expressed using coordinates (I,J). When a partial color average of the partial image data in a partial image specified by the coordinates (I,J) is expressed as X_{AV}(I,J), a horizontal direction n-order moment mₙₕ relating to the partial color average can be expressed by the following formula (6).

$${m}_{nh} = {\sum }_{I , J} {I}^{n} \times {x}_{av} ( I , J ) \qquad ( 6 )$$

Here, a value in which a simple first-order moment is divided by a sum total of partial color averages X_{AV}(I,J) is referred to as a first-order centroid moment. This first-order centroid moment is expressed by the following formula (7) and indicates a horizontal direction centroid position of partial characteristic amounts known as partial color averages. An n-order centroid moment in which the centroid moments are generalized is expressed by the following formula (8). Among these n-order centroid moments, it is generally thought that centroid moments of odd number orders (n=1, 3, . . . ) indicate centroid positions. And centroid moments of even number orders are generally thought to indicate an extent of spreading of characteristic amounts near the centroids.

$$\begin{matrix}{m}_{glh} = {\sum }_{I , J} I \times {x}_{av} ( I , J ) / {\sum }_{I , J} {x}_{av} ( I , J ) & ( 7 ) \\ {g}_{gnh} = {\sum }_{I , J} {( I - {m}_{gbc} )}^{n} \times {x}_{av} ( I , J ) / {\sum }_{I , J} {x}_{av} ( I , J ) & ( 8 )\end{matrix}$$

The overall characteristic amount obtaining section 52 according to the present embodiment obtains six types of moment. Specifically, it obtains a horizontal direction first-order moment, a vertical direction first-order moment, a horizontal direction first-order centroid moment, a vertical direction first-order centroid moment, a horizontal direction second-order centroid moment, and a vertical direction second-order centroid moment. It should be noted that the combination of moments is not limited to these. For example, it is possible to use eight types to which a horizontal direction second-order moment and a vertical direction second-order moment have been added.

By obtaining these moments it is possible to identify a color centroid and an extent of color spreading near the centroid. Examples of information that can be obtained include “a red area is spreading on an upper portion of the image” and “a yellow area is formed near the center.” Then, since centroid positions and localization of color can be considered in the classification processing by the classification processing section 30I (see FIG. 4), the accuracy of classification can be increased.

Regarding Normalization of Characteristic Amounts

In this regard, support vector machines (also referred to as SVMs) are used to carry out classification in the overall classifier 30F and the partial image classifier 30G that constitute a portion of the classification processing section 30I. Description is given later regarding support vector machines, but the support vector machines have a characteristic in that their influence (extent of weighting) on classification is larger for characteristic amounts having larger variances. Accordingly, the partial characteristic amount obtaining section 51 and the overall characteristic amount obtaining section 52 carry out normalization for the partial characteristic amounts and the overall characteristic amounts that have been obtained. Namely, normalization is carried out such that an average and a variance is calculated respectively for the characteristic amounts, and the average becomes a value [0] and the variance becomes a value [1]. Specifically, when an average value of an i^{th} characteristic amount xᵢ is set as μᵢ and its variance is set as σᵢ, a characteristic amount xᵢ′ after normalization can be expressed by the following formula (9).

xᵢ′=(xᵢ−μᵢ)/σ_{I} (9)

Accordingly, the partial characteristic amount obtaining section 51 and the overall characteristic amount obtaining section 52 normalize the characteristic amounts by carrying out the operation of formula (9). Normalized characteristic amounts are stored respectively in the characteristic amount storing section 37e of the memory 37 and used in the classification processing of the classification processing section 30I. This enables the characteristic amounts to be handled with a uniform weighting in the classification processing by the classification processing section 30I. As a result, classification accuracy can be increased.

Summary of the Characteristic Amount Obtaining Section 30E

The partial characteristic amount obtaining section 51 obtains a partial color average and a partial color variance as partial characteristic amounts and the overall characteristic amount obtaining section 52 obtains an overall color average and an overall color variance as the overall characteristic amounts. These characteristic amounts are used in the classification processing on the classification target image by the classification processing section 30I. For this reason, the classification accuracy in the classification processing section 30I can be increased. This is because information of a color shade and information of an extent of color localization that have been obtained for the overall classification target image and its partial images respectively are taken into account in the classification processing.

Regarding the Classification Processing Section 30I

Next, description is given regarding the classification processing section 30I. First, description is given regarding an outline of the classification processing section 30I. As shown in FIG. 4 and FIG. 5, the classification processing section 30I, is provided with the overall classifier 30F, the partial image classifier 30G, and the integrative classifier 30H. The overall classifier 30F performs classification on a scene of the classification target image based on an overall characteristic amount. The partial image classifier 30G performs classification on a scene of the classification target image based on partial characteristic amounts. The integrative classifier 30H performs classification on scenes of classification target images for which no scene was established by the overall classifier 30F and the partial image classifier 30G. In this manner, the classification processing section 30I is provided with a plurality of types of classifiers having different characteristics. This is so as to increase classification ability. That is, the overall classifier 30F can perform classification with excellent accuracy on scenes whose characteristics tend to be expressed in the classification target image overall. On the other hand, the partial image classifier 30G can perform classification with excellent accuracy on scenes whose characteristics tend to be expressed in a portion of the classification target image. As a result, accuracy in the classification ability of the classification target image can be increased. Further still, the integrative classifier 30H can perform classification on classification target images for which no scene was established by the overall classifier 30F and the partial image classifier 30G. In regard to this point also, accuracy in the classification ability of the classification target image can be increased.

Regarding the Overall Classifier 30F

The overall classifier 30F is provided with a plurality of sub classifiers (for convenience referred to as overall sub classifiers) of types corresponding to recognizable scenes. As shown in FIG. 5, the overall classifier 30F is provided with a landscape classifier 61, a sunset scene classifier 62, a night scene classifier 63, a flower classifier 64, and an autumnal foliage classifier 65 as overall sub classifiers. Each of the overall sub classifiers performs classification as to whether the classification target image pertains to a specific scene based on the overall characteristic amounts. Furthermore, each of the overall sub classifiers performs classification as to whether the classification target image does not pertain to a specific scene.

These overall sub classifiers are provided with a support vector machine and a determining section respectively. That is, the landscape classifier 61 is provided with a landscape support vector machine 61a and a landscape determining section 61b, and the sunset scene classifier 62 is provided with a sunset scene support vector machine 62a and a sunset scene determining section 62b. Furthermore, the night scene classifier 63 is provided with a night scene support vector machine 63a and a night scene determining section 63b, the flower classifier 64 is provided with a flower support vector machine 64a and a flower determining section 64b, and the autumnal foliage classifier 65 is provided with an autumnal foliage support vector machine 65a and an autumnal foliage determining section 65b. It should be noted, as is described later, that each of the support vector machines calculates a classification function value (probability information) corresponding to an extent to which the classification target image pertains to a specific category (scene) each time a classification target image, which is a classification target (evaluation target), is inputted. Then, the classification function values obtained by the support vector machines are stored in the probability information storing section 37f of the memory 37.

Based on the classification function value obtained by its corresponding support vector machine, each of the determining sections determines whether the classification target image pertains to its corresponding specific scene. Then, when any of the determining sections has determined that the classification target image pertains to its corresponding specific scene, it stores a positive flag in a corresponding area of the positive flag storing section 37h. Furthermore, based on the classification function value obtained by its support vector machine, each of the determining sections also determines whether the classification target image does not pertain to its specific scene. Then, when any of the determining sections has determined that the classification target image does not pertain to its specific scene, it stores a negative flag in a corresponding area of the negative flag storing section 37i. It should be noted that a support vector machine may also be used by the partial image classifier 30G. For this reason, description is given regarding the support vector machines together with the partial image classifier 30G.

Regarding the Partial Image Classifier 30G

The partial image classifier 30G is provided with a plurality of sub classifiers (for convenience referred to as partial sub classifiers) of types corresponding to recognizable scenes. Each of the partial sub classifiers corresponds to a partial classifier that determines that the classification target image pertains to a corresponding scene based on the partial characteristic amount. That is, each of the partial sub classifiers carries out an evaluation for each partial image as to whether or not the partial image pertains to the corresponding scene based on the partial characteristic amounts, and determines whether the classification target image pertains to a corresponding scene in accordance with an evaluation result thereof. These partial sub classifiers are to carry out classification, in order from partial images that correspond to a scene with high priority. That is, in the case where it is not determined that the classification target image pertains to a certain scene, with a certain partial sub classifier, it is determined with another partial sub classifier that the classification target image pertains to another scene. Here, the (certain) partial sub classifier at an earlier stage corresponds to a first partial classifier that determines that the classification target image pertains to the first scene, and the (another) partial sub classifier at a later stage corresponds to the second partial classifier that determines that the classification target image pertains to the second scene. In this way, determination is made for each scene so that the certainty of the classification can be increased.

Note that, in the case where the partial sub classifier at an earlier stage does not determine that the classification target image pertains to a certain scene, according to an evaluation result indicating that the partial image pertains to a certain scene, the partial sub classifier at an earlier stage determines that the classification target image does not pertain to another scene. In the case where it has been determined with the partial sub classifier at an earlier stage that the classification target image does not pertain to another scene, the partial sub classifier at a later stage corresponding to another scene does not perform classification processing regarding the classification target image. In other words, the partial sub classifier at an earlier stage has determined that the classification target image does not pertain to another scene, before the determination with the partial sub classifier at a later stage as to whether or not the classification target image pertains to another scene. Therefore, classification processing by the partial sub classifier at a later stage can be omitted, and the speed of classification processing can be increased.

Specifically, as shown in FIG. 5, the partial image classifier 30G in this embodiment is provided with a sunset scene partial sub classifier 71, a flower partial sub classifier 72, and an autumnal foliage partial sub classifier 73, as partial sub classifiers.

The sunset scene partial sub classifier 71 determines that the classification target image pertains to a sunset scene, according to an evaluation result indicating that the partial image pertains to a sunset scene. Further, in the case where the sunset scene partial sub classifier 71 does not determine that the classification target image pertains to a sunset image, determines that the classification target image does not pertain to a scene other than a sunset scene, according to an evaluation result indicating that the partial image pertains to a sunset scene.

The flower partial sub classifier 72 performs an evaluation as to whether or not partial images pertain to the flower scene, and, according to the evaluation result, determines that the classification target image pertains to a flower scene. It should be noted that, this determination is performed in the case where the scene of the classification target image is not decided with the sunset scene partial sub classifier 71 at an earlier stage. Further, this determination is not performed in the case where it is determined that the classification target image does not pertain to the flower scene with the sunset scene partial sub classifier 71. Then, in the case where the flower partial sub classifier 72 does not determine that the classification target image pertains to a flower scene, according to an evaluation result indicating that the partial image pertains to a flower scene, the flower partial sub classifier 72 determines that the classification target image does not pertain to a scene other than the flower scene.

The autumnal foliage partial sub classifier 73 performs an evaluation as to whether or not the partial image pertains to an autumnal foliage scene, and according to the evaluation result, determines whether the classification target image pertains to the autumnal foliage scene. It should be noted that this determination is performed in the case where the scene of the classification target image is not decided with the sunset scene partial sub classifier 71 and the flower partial sub classifier 72. Further, this determination is not performed in the case where it is determined that the classification target image does not pertain to an autumnal foliage scene with the sunset scene partial sub classifier 71 and the flower partial sub classifier 72. Then, in the case where the autumnal foliage partial sub classifier 73 does not determine that the classification target image pertains to an autumnal foliage scene, it determines that the classification target image does not pertain to scenes other than the autumnal foliage scene.

It should be noted that, the determination of a scene with each partial sub classifier is performed based on a comparison between the number of partial images for each of which an evaluation result that the partial image pertains to a corresponding scene has been obtained based on a partial characteristic amount, and a positive threshold or a negative threshold (described later). In this case, the number of the partial images obtained with evaluation results that the partial image pertains to a specific scene, corresponds to an evaluation value obtained with evaluation of each partial sub classifier.

When the number of types of scenes that are classification targets of the overall classifier 30F and the number of types of scenes that are classification targets of the partial image classifier 30G are compared, there is a smaller number of types of scenes that are classification targets of the partial image classifier 30G. This is because the partial image classifier 30G has an object of complementing the overall classifier 30F. That is, the partial image classifier 30G is provided for scenes for which accuracy is difficult to obtain using the overall classifier 30F.

Examined here are classification target images suitable for classification by the partial image classifier 30G. First, a flower scene and an autumnal foliage scene are examined. In regard to these scenes, the characteristics of both scenes can be considered easy to express locally. For example, in a classification target image involving a close-up shot of flowers, a characteristic of a flower scene is expressed in a central area of the image, and a characteristic proximal to a landscape scene is expressed in peripheral areas. The same is true for an autumnal foliage scene. That is, in a case where autumnal foliage expressed in a portion of a mountain surface has been shot, autumnal foliage will be collected in a specific portion of the classification target image. In this case also, a characteristic of an autumnal foliage scene is expressed in a portion of a mountain surface and characteristics of a landscape scene are expressed in other portions. Accordingly, by using the flower partial sub classifier 72 and the autumnal foliage partial sub classifier 73 as partial sub classifiers, classification ability can be increased even for flower scenes and autumnal foliage scenes that are difficult for the overall classifier 30F to classify. That is, classification is carried out on each partial image and therefore it is possible to perform classification with excellent accuracy even in the cases where a characteristic of a major subject such as a flower or autumnal foliage is expressed in a portion of the classification target image. Next, sunset scenes are examined. In sunset scenes also, there are cases where a sunset scene characteristic is expressed locally. For example, consider an image involving a shot of the evening sun setting on the horizon, this being an image that was shot at a timing immediately before the sun had completely set. In an image such as this, a characteristic of an evening sun scene is expressed in a portion where the evening sun is setting and characteristics of a night scene are expressed in other portions. Accordingly, by using the sunset scene partial sub classifier 71 as a partial sub classifier, classification ability can be increased even for sunset scenes that are difficult for the overall classifier 30F to classify. It should be noted, in regard to these scenes where characteristics tend to appear locally, that positions where there is a high probability of a characteristic of that scene to be expressed have a uniform tendency for each specific scene. Hereinafter, the probability of a characteristic of a specific scene to be expressed in each position of the partial images is also referred to as an existence probability.

In this manner, the partial image classifier 30G mainly carries out classification targeting images for which accuracy is difficult to obtain using the overall classifier 30F. In other words, the partial sub classifiers are not provided for classification targets for which sufficient accuracy can be obtained by the overall classifier 30F. By employing this configuration, the configuration of the partial image classifier 30G can be simplified. Here the partial image classifier 30G is configured by the main controller 31 and therefore simplification of configuration applies to reducing the size of the operation programs to be executed by the CPU 36 and the size of necessary data. Simplification of configuration enables the capacity of required memory to be reduced and enables higher speeds of processing.

In this regard, as mentioned earlier, the classification target images targeted for classification by the partial image classifier 30G are images whose characteristics tend to appear in portions. That is, there are many cases where a characteristic of a scene that is targeted does not appear in the classification target image other than its own portion. Accordingly, carrying out evaluations as to whether or not all the partial images obtained from the classification target image pertain to a specific scene does not necessarily improve the accuracy of scene classification, and also involves a risk of incurring reduced speeds in classification processing. In other words, by optimizing the number of partial images to be evaluated (hereinafter also referred to as the number of evaluations), it is possible to achieve increased speeds in classification processing without carrying out evaluations for all the partial images and without reducing the accuracy of classification. Consequently, in the present embodiment, classification is carried out as to whether or not a classification target image pertains to a specific scene by determining in advance an optimal number of evaluations of partial images for each specified scene and using evaluation results of only the partial images of the number of evaluations. Hereinafter, description is given focusing on this point.

Regarding Configurations of the Partial Sub Classifiers

First, description is given regarding the configurations of the partial sub classifiers (the sunset scene partial sub classifier 71, the flower partial sub classifier 72, and the autumnal foliage partial sub classifier 73). As shown in FIG. 5, each of the partial sub classifiers is provided with a partial support vector machine, a detection number counter, and a determining section respectively. That is, the sunset scene partial sub classifier 71 is provided with a partial support vector machine 71a for sunset scenes, a sunset scene detection number counter 71b, and a sunset scene determining section 71c, and the flower partial sub classifier 72 is provided with a partial support vector machine 72a for flowers, a flower detection number counter 72b, and a flower determining section 72c. Furthermore, the autumnal foliage partial sub classifier 73 is provided with a partial support vector machine 73a for autumnal foliage, an autumnal foliage detection number counter 73b, and an autumnal foliage determining section 73c.

In these partial sub classifiers, the partial support vector machine and the detection number counter correspond to a partial evaluation section, and carries out an evaluation based on partial characteristic amounts as to whether or not each partial image pertains to a corresponding scene. Then, each determining section uses the evaluation results of the partial evaluation section to determine that the classification target image pertains to the corresponding scene, and that the classification target image does not pertain to scenes other than the corresponding scene. In this case, each determining section uses the evaluation result of the partial evaluation section for only a part of the partial images. That is, each determining section uses the evaluation result of only a predetermined number of partial images selected from a part of the plurality of partial images constituting the classification target image.

Specifically, when the classification target image is constituted by 64 partial images as shown in FIG. 7, each determining section carries out a determination using evaluation results of only partial images corresponding to the predetermined number (for example, 10) of the partial areas. That is, each determining section determines that, without using the evaluation results of all the partial images, the classification target image pertains to a corresponding scene, and that it does not pertain to a scene other than the corresponding scene. By doing this, the number of times of classification by the partial evaluation section can be reduced, and therefore the speed of scene classification processing can be further improved. It should be noted that the number of evaluations for each scene is determined based on a percentage of correct responses (also referred to as precision) and a reproduction percentage (also referred to as recall), which are benchmarks indicating accuracy in scene classification by the determining sections (described later).

Furthermore, as is described later, it is preferable that the predetermined number of partial images targeted for evaluation is selected based on at least one of an existence probability, which is a probability that a characteristic of a specific scene is expressed in a partial area, and a partial precision, which is a probability that an evaluation result in each partial image by the partial evaluation section is correct.

The partial support vector machines (the partial support vector machine 71a for sunset scenes to the partial support vector machine 73a for autumnal foliage) provided in the partial sub classifiers are identical to the support vector machines (the landscape support vector machine 61a to the autumnal foliage support vector machine 65a) provided in the overall sub classifiers. Hereinafter, description is given regarding the support vector machines.

Regarding the Support Vector Machines

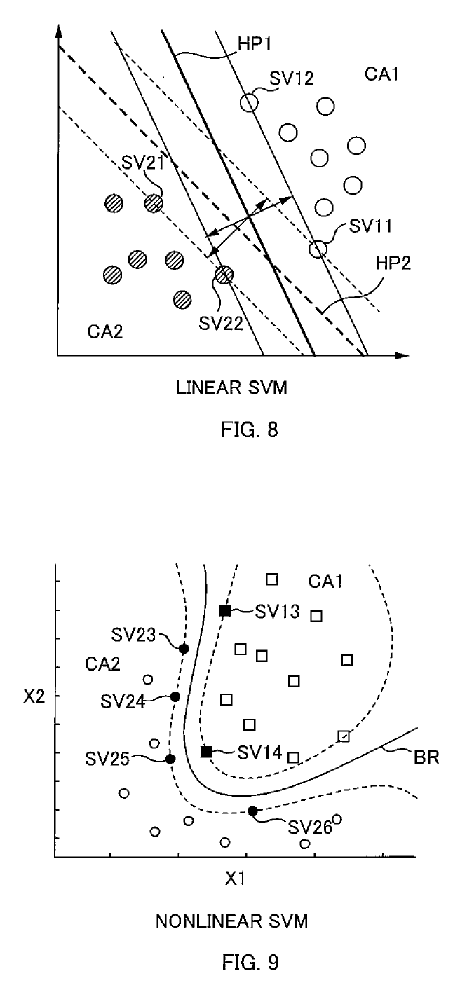

Based on characteristic amounts indicating characteristics of a classification target, the support vector machines obtain probability information that indicates a magnitude of probability that the classification target pertains to a certain category. A basic form of the support vector machines is linear support vector machines. As shown in FIG. 8 for example, a linear support vector machine involves a linear classification function established by two-class sorting training, and the classification function is established so that the margin (that is, the area where a support vector is not present as learning data) is largest. In FIG. 8, points (for example, SV11) that contribute to deciding a separating hyperplane among the white circles are a support vector pertaining to a certain category CA1, and points (for example, SV22) that contribute to deciding a separating hyperplane among the shaded circles are a support vector pertaining to another certain category CA2. In the separating hyperplane that separates the support vector pertaining to the category CA1 and the support vector pertaining to the category CA2, the classification function (probability information) that decides the separating hyperplane indicates a value [0]. In FIG. 8, a separating hyperplane HP1 parallel to a straight line passing through the support vectors SV11 and SV12 pertaining to the category CA1 and a separating hyperplane HP2 parallel to a straight line passing through the support vectors SV21 and SV22 pertaining to the category CA2 are shown as separating hyperplane candidates. In this example, the margin (an interval from the support vector to the separating hyperplane) of the separating hyperplane HP1 is larger than that of the separating hyperplane HP2, and therefore the classification function corresponding to the separating hyperplane HP1 is decided as the linear support vector machine.

Incidentally, with linear support vector machines, the accuracy of classification decreases undesirably for classification targets that cannot be separated linearly. It should be noted that the classification target images handled by the multifunction machine 1 correspond to classification targets that cannot be separated linearly. Accordingly, for these classification target images, characteristic amounts undergo nonlinear conversion (that is, are mapped to a higher-dimensional space) and nonlinear support vector machines are used to carry out classification of lines in that space. With these nonlinear support vector machines, a new function defined by an arbitrary number of nonlinear functions for example is used as data for the nonlinear support vector machine. As shown schematically in FIG. 9, in a nonlinear support vector machine, a classification border BR is curvilinear. In this example, points (for example, SV13 and SV14) that contribute to deciding the classification border BR among the points indicated by squares are a support vector pertaining to a category CA1, and points (for example, SV23 to SV26) that contribute to determining the classification border BR among the points indicated by circles are a support vector pertaining to a category CA2. And parameters of a classification function are determined according to learning using these support vectors. It should be noted that other points are used in learning, but these are untargeted in an optimization process. Thus, by using support vector machines in classification, it is possible to suppress the number of learning data (support vectors) used during classification. As a result, the accuracy of probability information to be obtained can be increased even with limited learning data.

Regarding the Partial Support Vector Machines

The partial support vector machines (the partial support vector machine 71a for sunset scenes, the partial support vector machine 72a for flowers, and the partial support vector machine 73a for autumnal foliage) provided in the partial sub classifiers are nonlinear support vector machines as described above. And parameters in the classification functions of each of the partial support vector machines are determined using learning based on different support vectors. As a result, features can be optimized for each partial sub classifier and the classification ability of the partial image classifier 30G can be improved. The partial support vector machines output a numerical value, that is, a classification function value, in response to the inputted image.

It should be noted that the partial support vector machines are different from the support vector machines provided in the overall sub classifiers in that the learning data of the partial support vector machines is partial image data. That is, the partial support vector machines carry out operations based on partial characteristic amounts that indicate characteristics of classification target portions. The results of operations by the partial support vector machines that is, the classification function values, are larger values for larger numbers of characteristics of certain scenes in which a partial image is the classification target. Conversely, the values are smaller for larger numbers of characteristics in partial images of other scenes that are not a classification target. Furthermore, in a case where a partial image has equivalent numbers of characteristics of a certain scene and characteristics of other scenes, the classification function value obtained by the partial support vector machine is the value [0].

Consequently, in regard to a partial image for which the classification function value obtained by the partial support vector machine is a positive value, it can be said that more characteristics are expressed for the scene targeted by that partial support vector machine than other scenes, that is, there is a high probability that it pertains to the targeted scene. Thus, carrying out the operation of the classification function value using the partial support vector machines that constitute a part of the partial evaluation section corresponds to an evaluation of whether or not a partial image pertains to a specific scene. Furthermore, sorting whether or not the partial image pertains to a specific scene in response to whether or not the classification function value thereof is positive corresponds to performing classification. In the present embodiment, each of the partial evaluation sections (the partial support vector machine and the detection number counter) carries out an evaluation for each partial image based on partial characteristic amounts as to whether or not the partial image pertains to a specific scene. The probability information obtained by the partial support vector machines is stored in the probability information storing section 37f of the memory 37.

Each of the partial sub classifiers according to the present embodiment is arranged for its corresponding specific scene. Each of the partial sub classifiers is provided with a set of a partial support vector machine as a partial evaluation section and a detection number counter respectively. Consequently, it can be said that a partial evaluation section is provided for each type of specific scene. And each of the partial evaluation sections carries out classification based on an evaluation by its partial support vector machine as to whether or not its target pertains to its corresponding specific scene. For this reason, features can be optimized for each partial evaluation section in accordance with settings of each of the partial support vector machines.

It should be noted that the partial support vector machines according to the present embodiment carry out operations that take into account overall characteristic amounts in addition to partial characteristic amounts. This is so as to increase the classification accuracy of partial images. This point is described below. The partial images involve a smaller amount of information compared to the overall image. For this reason, there are cases where scene classification is difficult. For example, classification is difficult in a case where a certain partial image has characteristics common to a certain scene and another scene. Suppose that a partial image is an image having a strong redness. In this case, with only the partial characteristic amounts it is difficult to classify whether that partial image pertains to a sunset scene or an autumnal foliage scene. In cases such as these, it is possible to classify the scene pertaining to the partial image by taking into account the overall characteristic amounts. For example, in a case where the image has an overall characteristic amount involving an overall blackish tinge, there is a high probability that the partial image with strong redness pertains to a sunset scene. Furthermore, in a case where the image has an overall characteristic amount involving overall tinges of green or blue, there is a high probability that the partial image with strong redness pertains to an autumnal foliage scene. In this manner, the classification accuracy can be further increased by carrying out classification based on operation results in which the partial support vector machines carry out operations that take into account an overall characteristic amount.

Regarding the Detection Number Counters

Each of the detection number counters (the sunset scene detection number counter 71b to the autumnal foliage detection number counter 73b) is caused to function by the counter section 37g of the memory 37. Furthermore, each of the detection number counters counts the number of partial images for which the evaluation result obtained by the corresponding partial support vector machine indicates that it is a corresponding scene.

An initial value of each of the detection number counters is the value [0] for example. Then a count-up (+1) is performed each time an evaluation result is obtained whose classification function value obtained by the corresponding partial support vector machine is a positive value (that is, an evaluation result indicating that it pertains to a specific scene which is a classification target). Performing this count-up is also referred to incrementing. In short, it can be said that the detection number counters count the number of partial images that have been classified (detected) as pertaining to the specific scene (hereinafter, also referred to as a corresponding scene), which is the classification target. And the values counted by the detection number counters quantitatively indicate an evaluation performed by the partial support vector machines. In the following description, the count value of the detection number counters is also referred to as a detected image number.

The count values of the detection number counters are reset and return to an initial value when, for example, processing is to be carried out for a new classification target image.

Regarding the Determining Sections

The determining sections (the sunset scene determining section 71c, the flower determining section 72c, and the autumnal foliage determining section 73c) are configured by the CPU 36 of the main controller 31 for example, and determine that the classification target image pertains to a corresponding specific scene in response to the detected image number of the corresponding detection number counter (the evaluation result obtained by the partial evaluation section). In this manner, by determining whether or not the classification target image pertains to a corresponding scene in response to the detected image number, the classification can be carried out with excellent accuracy even in a case where a characteristic of a corresponding scene is expressed in one portion of the classification target image. Accordingly, the classification accuracy can be improved. It should be noted that, specifically, in a case where the detected image number (the number of partial images for which an evaluation result has been obtained indicating that the classification target image pertains to a specific scene) exceeds a predetermined threshold stored in the parameter storing section 37b of the memory 37, the determining sections of each of the partial sub classifiers determine that this classification target image pertains to the corresponding scene. The predetermined threshold gives a positive determination that the classification target image pertains to the scene handled by the partial sub classifier. Accordingly, in the following description, the thresholds for giving a positive determination in this manner are also referred to as positive thresholds. The value of the positive threshold indicates a necessary detected image number for determining that the classification target image is the corresponding scene. Consequently, when the positive threshold is decided, a proportion of the detected image number to the number of evaluations of the partial images is decided. Thus, the accuracy of classification in respect to the corresponding scene can be adjusted according to a value of the positive threshold. It should be noted that from the viewpoints of processing speed and classification accuracy, it is conceivable that an optimal number for the detected image number to carry out determination may vary in response to the types of scenes that are classification targets. Consequently, the values of the positive thresholds are set respectively for each of the scenes that are a classification target for the partial sub classifiers. In this manner, the positive thresholds are set for each specific scene and therefore classification can be carried out suited to the respective scenes. That is, increased speeds of processing can be achieved while ensuring necessary classification accuracy.

Further, the determining sections of each of the partial sub classifiers determine that the classification target image does not pertain to the scene in the case where the detected image number exceeds a threshold different from the positive threshold, which has been stored in the parameter storing section 37b. This threshold is provided for each of the classification target scenes (hereinafter, referred to another scene) other than the scene corresponding to each of the partial sub classifiers, and gives a negative determination that the classification target image does not pertain to another scene. Accordingly, in the following description, the thresholds for giving a negative determination in this manner are also referred to as negative thresholds. It should be noted that details of the positive threshold and the negative threshold are described later.

Furthermore, as mentioned earlier, in this multifunction machine 1, recall and precision are used as benchmarks indicating exactness (accuracy) in the determinations by the determining sections.

Recall indicates a proportion of classification target images that have been determined to pertain to a certain scene with respect to the classification target images that should be determined as pertaining to that scene. In other words, recall refers to the probability that a classification target image pertaining to a specific scene is determined by the determining section corresponding to that specific scene to be pertaining to that specific scene. To put forth a specific example, in the case where a plurality of classification target images pertaining to a sunset scene have been classified by the sunset scene partial sub classifier 71, the proportion of the classification target images that have been classified as pertaining to a sunset scene corresponds to the recall. Accordingly, recall for classification target images having a reasonably low probability of pertaining to a particular scene can be increased by being determined by the determining section to be pertaining to that scene. It should be noted that a maximum value of recall is a value [1] and a minimum value is [0].

Precision indicates a proportion of classification target images correctly determined among classification target images determined to be pertaining to the corresponding scene by a certain determining section. That is, precision refers to the probability that the determination is correct when a classification target image has been determined to be pertaining to a specific scene by the corresponding determining section. To put forth a specific example, it corresponds to the proportion of classification target images among a plurality of images classified by the sunset scene partial sub classifier 71 as pertaining to a sunset scene that actually pertain to a sunset scene. Accordingly, precision for classification target images having a high probability of pertaining to a particular scene can be increased by being determined selectively by the determining section to be pertaining to that scene. It should be noted that a maximum value of precision is a value [1] and a minimum value is [0].

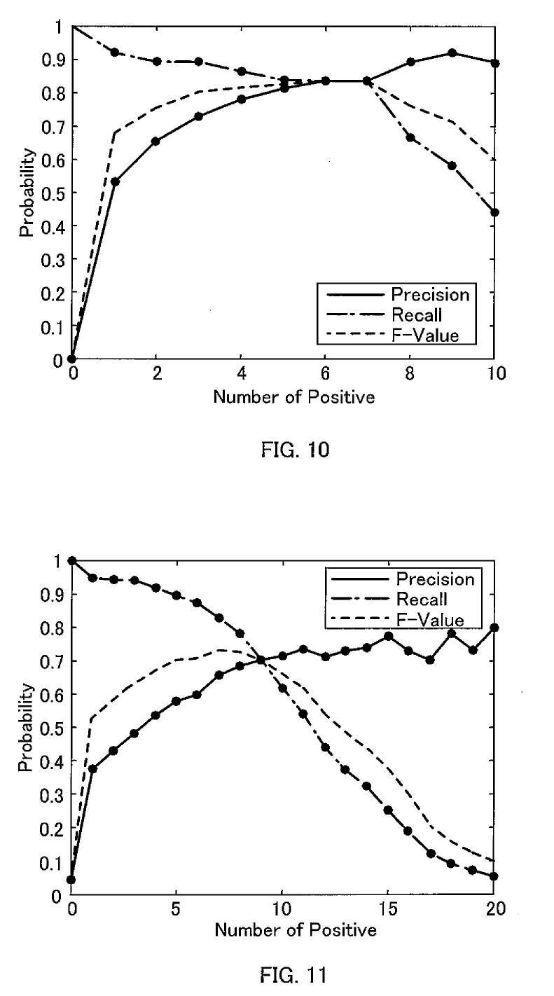

FIG. 10 shows precision and recall characteristics of the sunset scene partial sub classifier 71, and FIG. 11 shows precision and recall characteristics of the flower partial sub classifier 72. It should be noted that the horizontal axis in FIG. 10 and FIG. 11 indicates the positive threshold and the vertical axis indicates recall and precision values. As is evident from these diagrams, precision and recall have a mutually reciprocal relationship with respect to the positive threshold. For example, precision has a tendency to increase for larger positive thresholds. Thus, with larger positive thresholds, the probability increases that classification target images that have been determined to pertain to a sunset scene will in fact pertain to a sunset scene for example. On the other hand, recall has a tendency to decrease for larger positive thresholds. For example, even classification target images of sunset scenes that should be classified as sunset scenes by the sunset scene partial sub classifier 71 will become difficult to classify correctly as pertaining to a sunset scene. Here, in the case of the present embodiment, the positive threshold refers to the number of detected images necessary for determining that the classification target image is the specific scene. Consequently, whether or not a classification target image is a specific scene is determined by whether or not the positive threshold is exceeded by the number of partial images for which an evaluation result has been obtained to the effect that it is the specific scene. That is, determination for a specific scene can be achieved more quickly for smaller positive thresholds, and the speed of classification processing can be improved. However, in this case, the precision is reduced and therefore the possibility of classification errors increases. Conversely, the accuracy of classification increases for larger positive thresholds. However, in this case, determining that it is a specific scene is made more difficult and the speed of classification processing is reduced. In this way, the accuracy and speed of classification processing is dependent on the values of precision and recall. It should be noted that an F value (F-value) shown in FIG. 10 and FIG. 11 is a function value prescribed by precision and recall, and can also be said to be a harmonic mean. The F value is expressed by the following formula (10) using precision and recall.

F=(2×Precision×Recall)/(Precision+Recall) (10)

The F value is known as a function value for optimizing with excellent balance indices having a mutually reciprocal relationship (precision and recall in the case of the present embodiment). The F value is largest near a cross point of precision and recall, and becomes smaller along with either one of precision or recall becoming smaller. That is, a large value of the F value indicates an excellent balance of precision and recall, and a small value of the F value indicates a poor balance between precision and recall (either being small). Accordingly, using the F value enables precision and recall to be evaluated collectively. Furthermore, in the present embodiment, the number of evaluations for each scene is determined using the F value defined by Precision and Recall, and therefore a number of evaluations can be determined that harmonizes accuracy and speed in classification processing.

Regarding the Partial Images

In the case of the present embodiment, the partial images by which classification is carried out by each of the partial sub classifiers of the partial image classifier 30G are 1/64 size (1, 200 pixels) of the classification target image as described using FIG. 7. That is, the classification target image has 64 partial images. It should be noted that in the following description, partial images specified by the vertical position J (J=1 to 8) and the horizontal position I (I=1 to 8) are expressed using the coordinates (I,J) also.

The partial sub classifiers according to the present embodiment select a predetermined number of partial images from all (64 in the present embodiment) of partial images obtained from the classification target image. Then classification is carried out for the selected partial images. In the present embodiment, as is described later, classification is carried out by selecting partial images in order of higher multiplication values of the existence probability and the precision (hereinafter also referred to as partial precision) of each partial image.

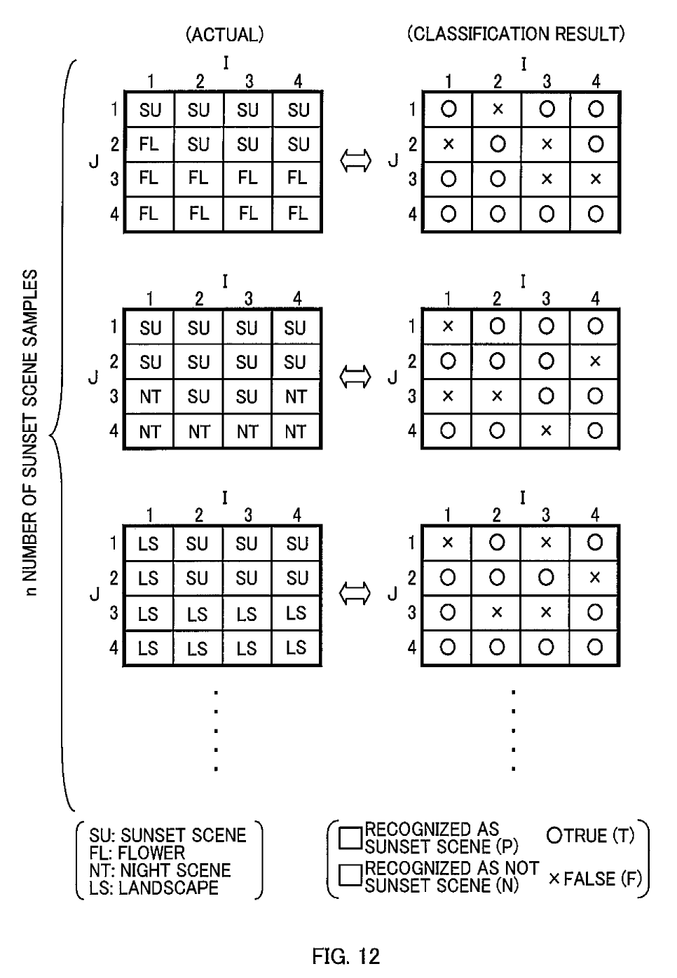

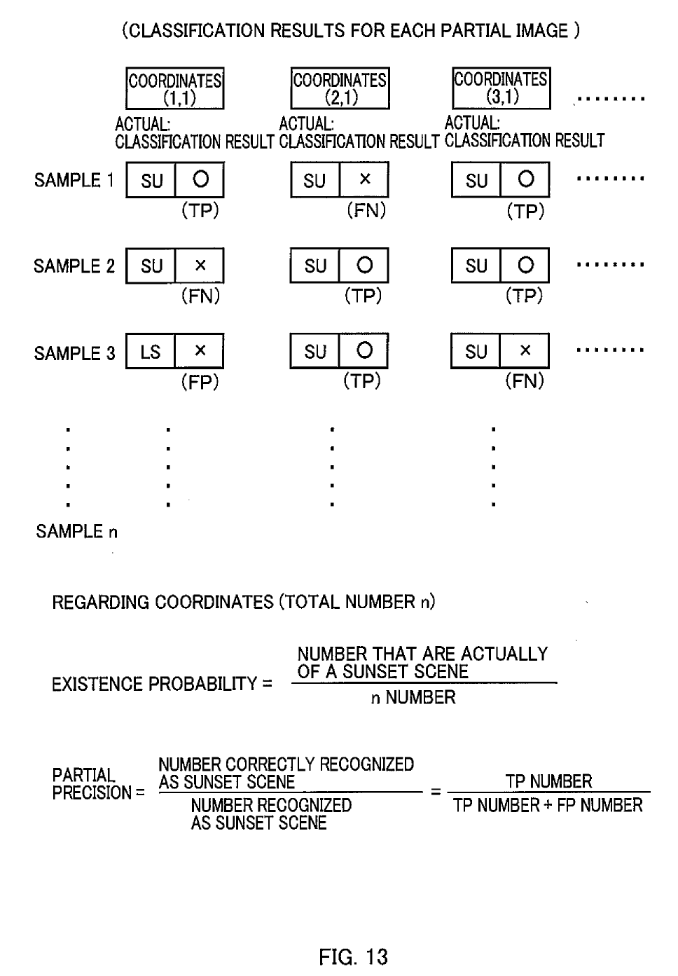

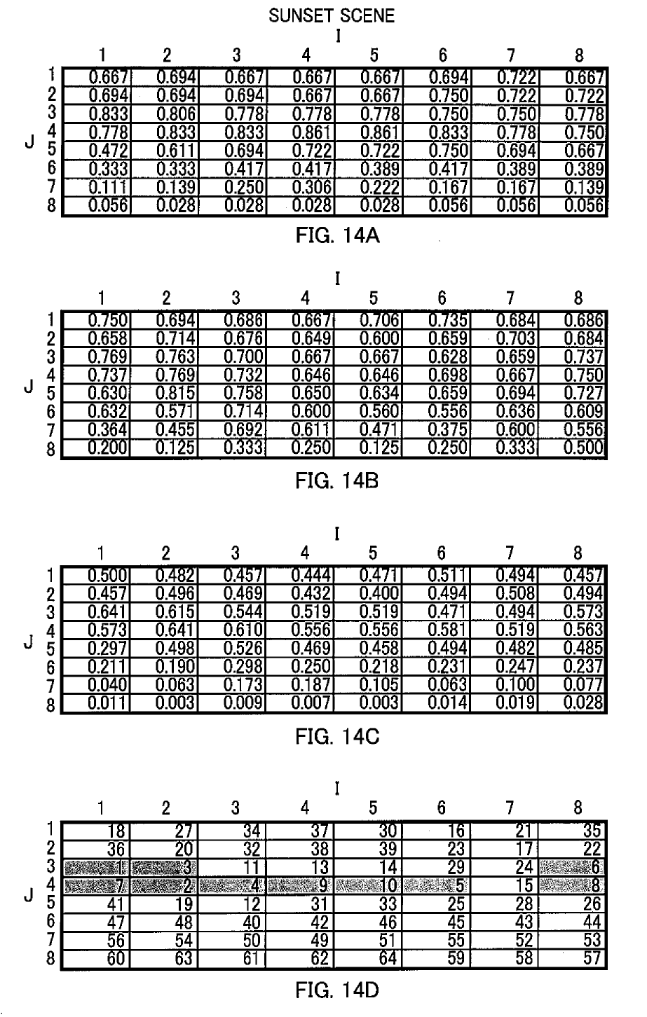

Hereinafter, description is given regarding the existence probability and the partial precision using FIG. 12 to FIG. 16D. FIG. 12 is a diagram showing one example of actual scenes and classification results of the partial sub image classifiers, and FIG. 13 is a diagram for describing a method for calculating the existence probability and the partial precision of each partial image. FIG. 14A to FIG. 16D are examples of existence data probability and the like. It should be noted that in FIG. 12, for convenience, 16 blocks (I=1 to 4, J=1 to 4) are shown of the 64 blocks, which are divided into 64 from the overall sample image. In the classification target image for which classification is to be carried out by the partial image classifier 30G, characteristics of scenes are expressed partially. For example, as shown in FIG. 12, in a sample image of a sunset scene there are partial images present in which characteristics are expressed not only of the sunset scene but also of other scenes (for example, flower, night scene, and landscape). It should be noted that the actual scenes shown in FIG. 12 are results in which each of the partial areas of the sample image is sorted into a specific scene by a person performing visual evaluation for example. In contrast to this, the classification results are results in which the same sample image has undergone classification by the partial evaluation section of the sunset scene partial sub classifier 71 (the partial support vector machine 71a for sunset scenes and the sunset scene detection number counter 71b) as to whether or not each partial image is of a sunset scene. In these classification results, gray shaded portions indicate partial images that have been classified as pertaining (positive) to the sunset scene, and white portions indicate partial images that have been classified as not pertaining (negative) to sunset scene. Furthermore, a circle is placed in partial areas whose classification result is the same as the actual scene (correct, also referred to as “true”), and a cross is placed in partial areas whose classification result is different from the actual scene (incorrect, also referred to as “false”).

Regarding Existence Probability

Existence probability refers to a probability that a characteristic of a specific scene is expressed in the partial areas within the image overall area. The existence probability is obtained by dividing a number of partial images in which a characteristic of a specific scene is actually expressed in the partial areas by a total number of sample images (total number n of partial images). Accordingly, for a partial area having no partial image in which a characteristic of the specific scene is expressed in the sample image, the existence probability is the minimum value [0]. On the other hand, for a partial area in which a characteristic of the specific scene is expressed in all the partial images, the existence probability is the maximum value [1]. Since the sample images have different compositions respectively, the accuracy of the existence probability is dependent on the number of sample images. That is, when there are a small number of sample images, there is a possibility that it will not be possible to correctly obtain the tendency of areas in which the specific scene is expressed. In the present embodiment, when obtaining the existence probability of the partial images, an n number (for example, several thousand) sample images of different compositions are used, and therefore the tendencies of positions in partial areas where the characteristic of the specific scene tends to be expressed can be obtained very exactly, and the accuracy of the existence probability for each of the partial areas can be increased. One example of data showing existence probabilities for each of the partial areas obtained from the sample images in this manner are shown in FIG. 14A to FIG. 16A. It should be noted that the 64 partial areas correspond respectively to the partial images shown in FIG. 7. Accordingly, the partial areas are indicated using the same coordinates (I,J) as the partial images.

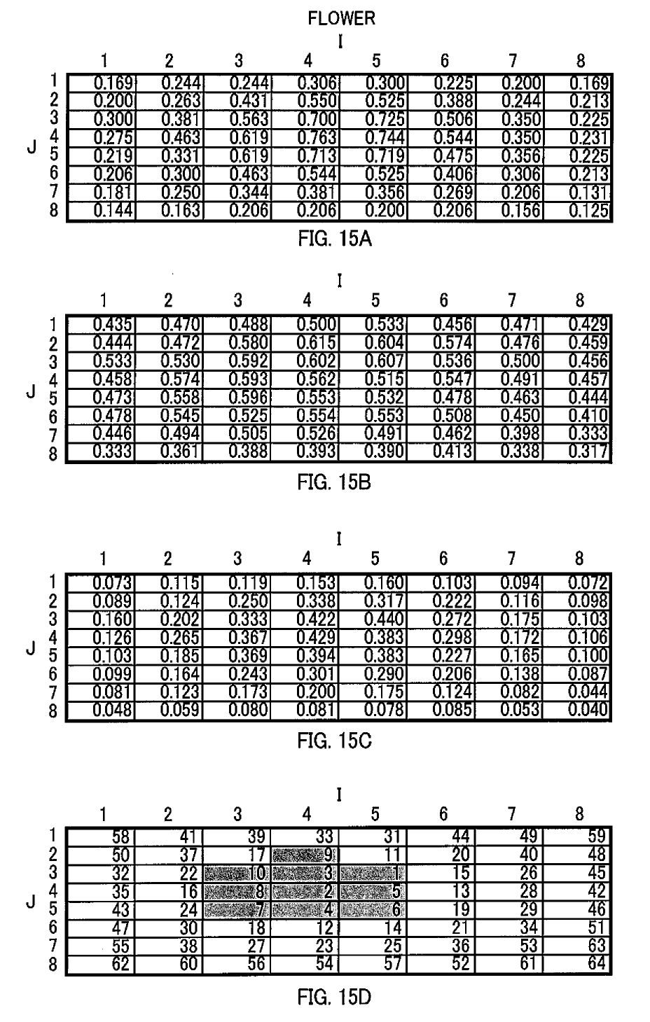

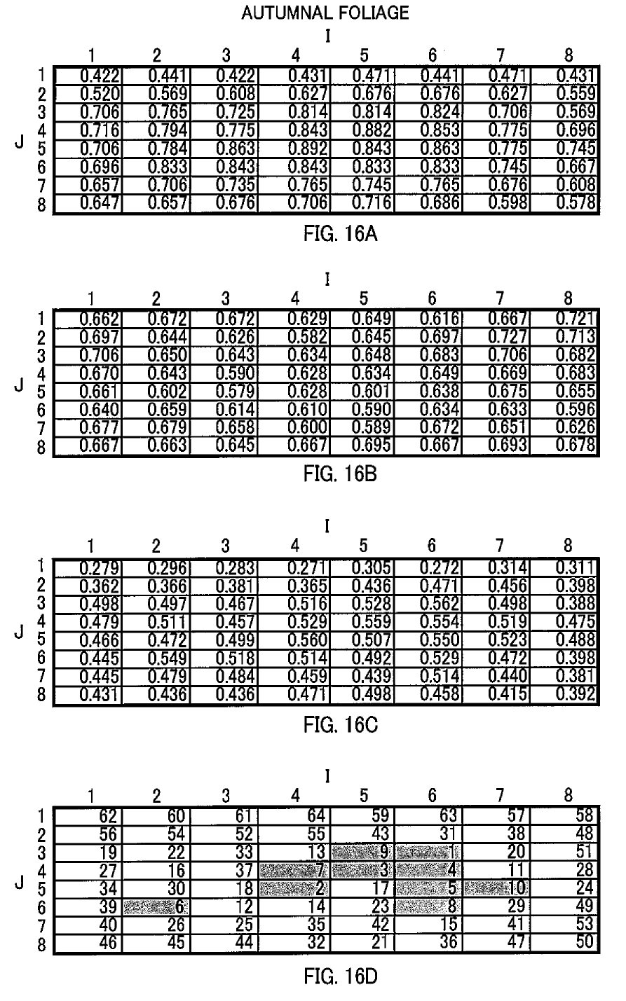

FIG. 14A shows data indicating existence probabilities in partial areas of a sunset scene, and FIG. 15A shows data indicating existence probabilities in partial areas of a flower scene. Furthermore, FIG. 16A shows data indicating existence probabilities in partial areas of an autumnal foliage scene.

For example, in a case of a sunset scene, it is common for a sunset scene sky to be spreading across an upper half of the overall image from a central vicinity. That is, as shown in FIG. 14A, the existence probabilities are high in partial areas of the upper half from the central vicinity of the overall area, and the existence probabilities are low in other partial areas (the lower half). Furthermore, in the case of a flower scene for example, compositions are common in which a flower is positioned in the center of the overall area as in FIG. 7. That is, as shown in FIG. 15A, the existence probabilities are high in partial areas of a central portion in the overall area, and the existence probabilities are low in partial areas of peripheral portions of the overall area. Furthermore, in a case of an autumnal foliage scene for example, it is common for autumnal foliage to be shot appearing in a portion of a mountain, such that the existence probabilities are high from a center of the image across a lower portion as shown in FIG. 16A. In this manner, it is evident that partial areas having high existence probabilities in sunset scene, flower, and autumnal foliage scenes where characteristics of a portion of a major subject tend to be expressed, such as those for which classification is carried out by the partial image classifier 30G, have a fixed tendency in each scene.

Regarding Partial Precision

Partial precision refers to a probability that an evaluation result of a partial image by the partial evaluation section (the partial support vector machine and the detection number counter) of the partial sub classifiers is correct. That is, it indicates a probability that the characteristic of a specific scene is actually expressed in a partial image for which a positive value classification function value was obtained by the partial evaluation section indicating that the probability of it pertaining to the corresponding specific scene is high.

The partial precision for each of the partial areas is obtained by dividing the number of partial images having a characteristic of a specific scene actually expressed among partial images classified as pertaining to the specific scene by the number of partial images classified as pertaining to the specific scene when classification has been performed by the partial evaluation section as to whether or not the partial images of a plurality of sample images pertain to a specific scene. For example, in a case where classification has been carried out by the sunset scene partial sub classifier 71, the partial precision for each of the partial areas is a value in which the number of partial images classified as sunset scene and set as correct (true positive: hereinafter also referred to as TP) is divided by the number of partial images classified as the sunset scene. It should be noted that the number classified as the sunset scene is a value in which the number of partial images set as true positive (TP) is added the number that was classified as the sunset scene but was incorrect (false positive: hereinafter also referred to as FP). That is, the partial precision is a minimum value [0] when TP=0 (FP>0), and is a maximum number [1] when FP=0 (TP>0).

For example, consider the three sample images (sample 1 to sample 3) shown in FIG. 13. In this case, in the partial area of the coordinates (1,1) there are two partial images classified as the sunset scene, one of which is correct (TP=1 and FP=1), and therefore the partial precision in the partial area in the case of the coordinates (1,1) is the value [½]. Furthermore, in the coordinates (2,1) and the coordinates (3,1) there are two partial images classified as the sunset scene, both of which are correct (TP=2 and FP=0), and therefore the partial precision in the partial area in the case of the coordinates (2,1) is the value [1]. In the present embodiment, when obtaining the precision of the partial images, an n number (for example, several thousand) sample images of different compositions are used in a same manner as for the existence probability, and therefore the tendencies of partial areas can be obtained very exactly, and the accuracy of the partial precision can be increased.

FIG. 14B, FIG. 15B, and FIG. 16B show one example of partial precision calculated for each partial area of sunset scene, flower, and autumnal foliage scenes using a plurality of sample images respectively. As is evident from these diagrams, a tendency of ranking of high partial precision is different from a tendency of ranking of high existence probability. This is due to the tendencies for high existence probabilities between each scene and characteristics of these scenes. For example, in a case where partial areas having high existence probabilities are the same in a certain scene and another scene, and the characteristics of both these scenes are similar, there are cases where carrying out correct classification will be difficult. Specifically, as shown in FIG. 14A and FIG. 16A, the partial areas of coordinates (5,4) both have high existence probabilities as a sunset scene and an autumnal foliage scene. That is, characteristics of a sunset scene and characteristics of an autumnal foliage scene both tend to be expressed in the partial images of the coordinates (5,4). However, the autumnal foliage scene and the sunset scene both have a characteristic of strong redness. For this reason, when carrying out classification with the sunset scene partial sub classifier 71 for example, even when the partial area of the coordinates (5,4) are of an autumnal foliage scene for example, there is a high possibility that this will be classified incorrectly as a sunset scene. Similarly, when carrying out classification with the autumnal foliage partial sub classifier 73, even when the partial area of the coordinates (5,4) for example are of a sunset scene, there is a high possibility that this will be classified incorrectly as an autumnal foliage scene. Due to this, in the partial areas of the coordinates (5,4) in the sunset scene and the autumnal foliage scene there is a high existence probability compared to other partial areas but the partial precision is low.

In this manner, the ranking of high partial precision is different from the ranking of high existence probability. In other words, in the image overall region, there are partial areas where relatively the existence probability is high but the partial precision is low, and conversely there are partial areas where the existence probability is low but the partial precision is high.

Regarding Classification Sequences of Partial Images

From the evaluation results of only the predetermined number of partial images, the determining section of each of the partial sub classifiers determines that the classification target image pertains to the specific scene. This determination is performed based on the evaluation results of partial images selected from a part of all the partial images that constitute the classification target image. Accordingly, it is preferable that the predetermined number of partial images are selected so as to enable evaluation to be carried out efficiently. For example, as mentioned earlier it is common that, in an image involving a close-up shot of flowers, a characteristic of a flower scene is expressed in a central area of the image overall and a characteristic proximal to a landscape scene is expressed in peripheral areas. In this case, when (for example, ten) partial images from the periphery of the image are selected, even though the scene of the classification target image is a flower scene, the possibility that it will be determined as a flower scene is low. Furthermore, in a case where there are multiple scenes in which a similar characteristic tends to appear in a same position, the possibility that a correct evaluation result is obtainable is low when a partial image of that position is selected to evaluate whether or not it pertains to the specific scene. In this way, the possibility that the scene of the classification target image will be correctly determined is low. Consequently, it is preferable that the predetermined number of partial areas targeted for evaluation are selected based on at least one of an existence probability, which is a probability that a characteristic of a specific scene is expressed in a partial area, and a partial precision, which is a probability that an evaluation result in each partial image by the partial evaluation section is correct. For example, when carrying out evaluations in order from partial areas having high existence probabilities, the evaluations can be carried out on the classification target image from positions (coordinates) having a high probability that the characteristic of that scene will be expressed. That is, partial areas having a low probability that characteristics of the specific scene will be expressed have a high possibility of being excluded from the evaluation targets. Furthermore, when carrying out evaluations in order from partial areas having high partial precision, the evaluations can be carried out in order by the partial evaluation section from partial areas having a high possibility that a correct evaluation result will be obtainable. That is, partial areas tending to produce evaluation errors have a high possibility of being excluded from the evaluation targets. Accordingly, in these cases, compared to a case where the predetermined number of partial areas are selected without establishing a selection method (that is, randomly), it is possible to correctly determine scenes pertaining to the classification target image. It should be noted that the present embodiment takes into account the existence probability and precision. For example, in the partial evaluation section, evaluations and classification are carried out in order from partial images corresponding to partial areas having high multiplication values of existence probability and precision. In other words, in each of the partial sub classifiers, evaluations and classification are carried out in order from partial images corresponding to partial areas where the probability that a characteristic of the corresponding specific scene will be expressed is high and where there is a high probability that the classification results in which the specific scene is classified will be correct. Due to this, very appropriate partial images can be targeted and the classification of specific scenes can be made even more efficient.

FIG. 14C shows data (hereinafter also referred to as multiplication value information) indicating multiplication values obtained by multiplying the existence probability (FIG. 14A) and the partial precision (FIG. 14B) of each of the partial areas in the sunset scene, and FIG. 14D shows data (hereinafter also referred to as multiplication value ranking information) indicating a ranking of multiplication values of each of the partial areas. Furthermore, FIG. 15C shows multiplication value information in which the existence probability (FIG. 15A) and the partial precision (FIG. 15B) of the flower scene have been multiplied for each of the partial areas, and FIG. 15D shows multiplication value ranking information thereof. Furthermore, FIG. 16C shows multiplication value information in which the existence probability (FIG. 16A) and the partial precision (FIG. 16B) of the autumnal foliage scene have been multiplied for each of the partial areas, and FIG. 16D shows multiplication value ranking information thereof. Either one of the multiplication value information or the multiplication value ranking information for these specific scenes is stored as selection information in the selection information storing section 37k of the memory 37. And the selection information is stored in the selection information storing section 37k as table data associated with values indicating coordinates. It should be noted that in FIGS. 14D, 15D, and 16D, in order to make more readily apparent the distribution of partial areas having high multiplication values of existence probability and partial precision, 10 areas (1st to 10th) of positions having the highest multiplication values respectively are shaded dark gray and the next 10 areas (11th to 20th) are shaded light gray.

When a determining section of each of the partial sub classifiers is to carry out a determination as to whether or not the classification target image pertains to a specific scene, the evaluation results for the partial images of a predetermined number (for example, 10) selected from the higher side of the multiplication values are used. For example, in each of the partial evaluation sections, evaluations are carried out in order from partial images having a higher ranking multiplication value. Then, using the evaluation results up to the predetermined number of evaluations, each determining section determines whether the classification target image pertains to a specific scene (that is, whether the number of partial images for which an evaluation result has been obtained indicating that it is the specific scene has exceeded the positive threshold).

For example, in a case of carrying out classification using the sunset scene partial sub classifier 71, based on the selection information for the sunset scene (either of the multiplication value information shown in FIG. 14C or the multiplication value ranking information shown in FIG. 14D), the partial image of coordinates (1,3) having the highest multiplication value in the sunset scene is selected first. Then, after classification processing of the partial image of the coordinates (1,3), the partial image of coordinates (2,4) having the second highest multiplication value is selected. Thereafter, partial images are selected in a same manner in order of highest multiplication values. And in a case where the number of evaluations is 10 for example, the partial image of the coordinates (5,4) is selected last (10th).

Furthermore, in a case where classification is to be carried out using the flower partial sub classifier 72, based on the selection information for the flower scene (either of FIG. 15C or FIG. 15D), selection is carried out in order from partial images corresponding to the partial area having the highest multiplication value of the existence probability and the partial precision in the flower scene. Furthermore, in a case where classification is to be carried out using the autumnal foliage partial sub classifier 73, based on the selection information for the autumnal foliage scene (either of FIG. 16C or FIG. 16D), selection is carried out in order from partial images corresponding to the partial area having the highest multiplication value of the existence probability and the partial precision in the autumnal foliage scene.

Regarding Selection of the Number of Evaluations of Partial Image

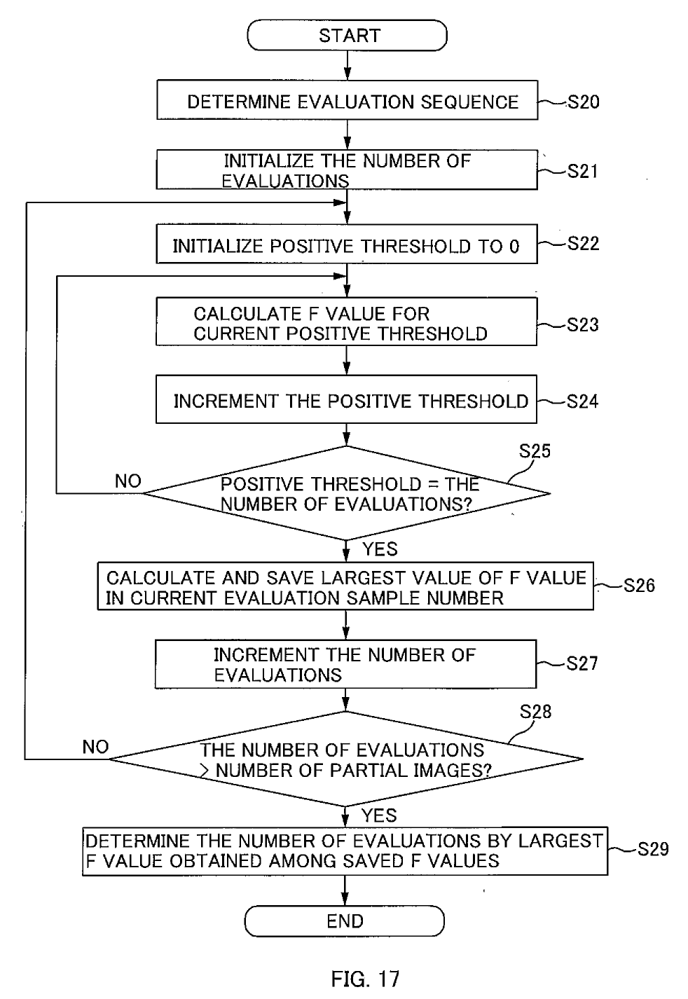

Next, using FIG. 17, description is given regarding one example of a method for selecting the number of evaluations of partial images in each scene. It should be noted that the flowchart shown in FIG. 17 is carried out for each of the partial sub classifiers by using in advance a plurality of sample images. Furthermore, the flowchart is executed for example using functionality of the CPU 36 and the memory 37 of the main controller 31 of the multifunction machine 1. For example, a program for executing this flowchart is stored in the program storing section 37a of the memory 37 and the various operations are carried out by the CPU 36. Furthermore, the positive thresholds are stored in the parameter storing section 37b for example, and the number of evaluations are stored in the detection number counter sections for example.

As shown in FIG. 17, first, an evaluation sequence is decided for the sample images (S20). This is achieved by the CPU 36 reading in selection information stored in the selection information storing section 37k. In the case of the present embodiment, as mentioned earlier, either one of multiplication value information, which the existence probability and the partial precision are multiplied, or the multiplication value ranking information, which indicates a ranking of multiplication values, is stored in the selection information storing section 37k as selection information. Accordingly, based on the selection information that is read out from the selection information storing section 37k, evaluations are carried out in order of partial images having higher multiplication values of the existence probability and partial precision.

Once the evaluation sequence has been decided, the number of evaluations is initialized (S21) and the number of evaluations of partial areas for which evaluation is to be carried out among the 64 partial areas of the sample image is provisionally determined. The provisionally determined number of evaluations is referred to as provisional evaluation number. In a case where the provisional evaluation number has been set to 0, classification is not carried out by the partial evaluation section, and therefore for convenience of description, description is given from a case where the provisional evaluation number is 10. In this case, 10 partial images are evaluation targets in order of highest existence probability and partial precision among the 64 partial images obtained by dividing the sample image.

Following this, the positive threshold is initialized (for example, to zero) (S22) and precision and recall are calculated in regard to the positive threshold that has been set from evaluation results of the partial images of the plurality of plurality of sample images. Then, using the precision and recall that have been calculated, the F value is calculated (S23) using the aforementioned formula (10). Once the F value has been calculated, the positive threshold is incremented (S24) by 1 for example, and a determination is performed (S25) as to whether or not the positive threshold is equivalent to the provisional evaluation number. In this case, a determination is performed as to whether or not the incremented positive threshold (which is the current positive threshold) is 10. When the current positive threshold is not equivalent to the provisional evaluation number (no at S25), step S23 in which the F value is calculated is executed again for the positive threshold. On the other hand, when the current positive threshold is equivalent to the provisional evaluation number (yes at S25), then a maximum value of the F value is calculated for the provisional evaluation number (which in this case is 10) and is stored as a control parameter in the parameter storing section 37b of the memory 37 for example (526). For example, in a case of an evaluation result of FIG. 10 (where the number of evaluations is 10), an F value of a value [0.82] when the positive threshold is the value [6] is selected as the maximum value. The value of the provisional evaluation number at this time (for example, 10) is associated with the maximum value of the F value and stored in the parameter storing section 37b. Once the maximum value of the F value has been stored, the provisional evaluation number is incremented by a predetermined number (S27). In the present embodiment, the predetermined number is established as 10. For this reason, in a case where the provisional evaluation number until then has been 10, the next provisional evaluation number becomes 20.

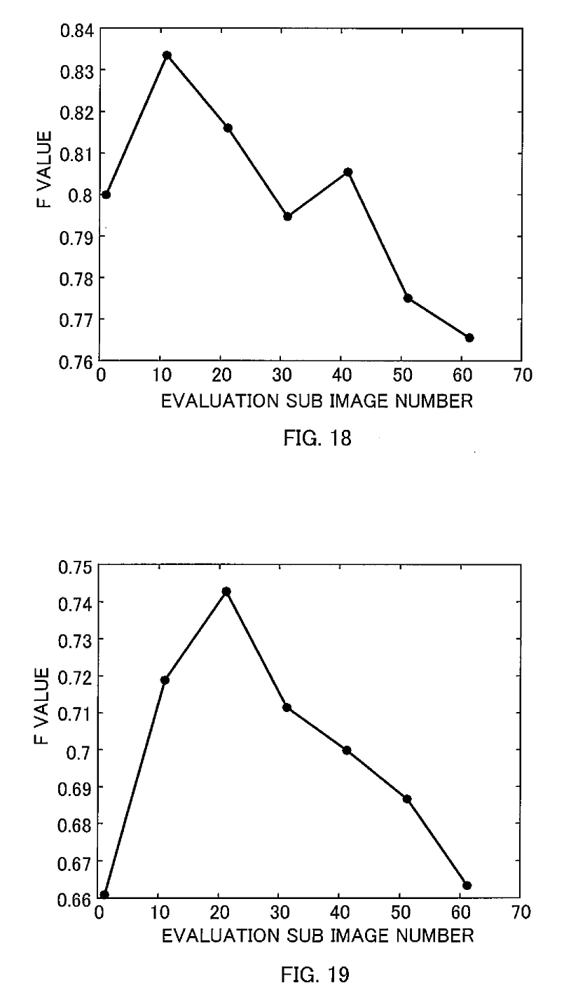

When the incremented provisional evaluation number is equal to or less than the total number (64) of partial images (no at S28), the procedure transitions to step S22 and the aforementioned processing is executed again. On the other hand, when the incremented provisional evaluation number is greater than the total number of partial images (yes at S28), the CPU 36 references the maximum value of the F value obtained for each provisional evaluation number, which are saved in the parameter storing section 37b. Then, the provisional evaluation number of when the values among the maximum values of the obtained F value become largest is determined as the number of evaluations for that scene (S29). Single examples of maximum values of F values with respect to the provisional evaluation number obtained in accordance with the above flowchart are shown in FIG. 18 and FIG. 19.

FIG. 18 is a diagram showing a single example of variation in the maximum value of the F value with respect to the provisional evaluation numbers in a sunset scene, and FIG. 19 is a diagram showing a single example of variation in the maximum value of the F value with respect to the provisional evaluation numbers in a flower scene. The horizontal axis in FIG. 18 and FIG. 19 shows the provisional evaluation number and the vertical axis shows the maximum values of F values for each provisional evaluation number. In the sunset scene, the maximum value of the F value is a largest value of [0.835] when the provisional evaluation number is 10 as shown in FIG. 18. Furthermore, in the flower scene, the maximum value of the F value is a largest value of [0.745] when the provisional evaluation number is 20 as shown in FIG. 19.

Here, when comparing the maximum value of the F value in a case where the provisional evaluation number is 10 in FIG. 18 for example and a maximum value of the F value in a case where the provisional evaluation number is 20, maximum value of the F value is smaller in the case where the provisional evaluation number is 20. That is, the maximum value of the F value is reduced by increasing the provisional evaluation number. This is because determination errors sometimes increase due to an increase in the provisional evaluation number. For example, there are cases where a positive threshold is reached by a provisional evaluation number of 10 when the positive threshold is set, and there are cases where a positive threshold is reached by a provisional evaluation number of 20 without the positive threshold being reached by a provisional evaluation number of 10. However, in the latter case, a determination that the classification target image pertains to the specific scene may be erroneous due to the positive threshold being reached. When there are many cases such as this, the value of the F value in the positive threshold may become lower than when the number of evaluations is 10.

In this manner, the provisional evaluation number at a time of the largest value among the maximum values of the F values, which is obtained as the provisional evaluation number, is determined as the number of evaluations for that scene. That is, the number of evaluations is determined as 10 for the sunset scene and the number of evaluations is determined as 20 for the flower scene. Furthermore, although omitted from the diagram, the number of evaluations is similarly determined as 10 for the autumnal foliage scene also. In this manner, an optimal number of evaluations for each scene varies respectively. In the present embodiment, the number of evaluations is determined for each specific scene based on the precision and recall of the determining section by carrying out a selection of the aforementioned number of evaluations for each specific scene. This enables classification processing to be carried out efficiently for each specific scene. It should be noted that the variance in optimal number of evaluations for each specific scene is conceivably due to such factors as characteristics of the composition of each scene and the difficulty of classification thereof. For example, a reason for a flower scene to have a greater number of evaluations than other scenes (sunset scene, autumnal foliage scene) may be that there are various compositions of images in the flower scene such as images where a flower has been shot centrally in a close-up and images where a field of flowers has flowers shown across a whole surface for example, and scene classification would be difficult (accuracy would be low) with a small number of evaluations.

As described above, in the present embodiment, by setting a plurality of positive thresholds in a range of provisional evaluation numbers by which number of evaluations of sample images have been provisionally determined, the F value is obtained for each threshold and a maximum value of the F value for the provisional evaluation number is obtained. Then the provisional evaluation number is varied to similarly obtain maximum value F values and the provisional evaluation number when the value is largest among the maximum values of F values that have been obtained is determined as the number of evaluations for that scene. In this manner the provisional evaluation number is varied to obtain maximum value F values and to determine the provisional evaluation number when the largest value among the maximum values of F values that have been obtained as the number of evaluations for the specific scene, and therefore the number of evaluations for each of the specific scenes can be optimized.

Regarding Positive Threshold

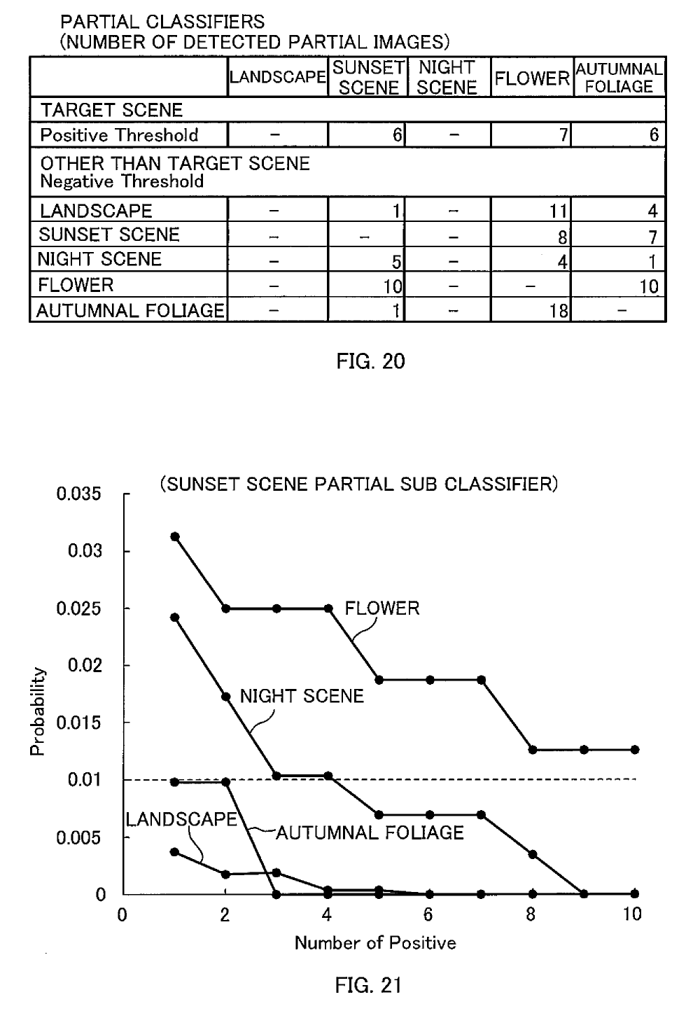

The positive threshold for each scene corresponding to each partial sub classifier is set respectively, based on the precision and recall of the number of evaluations that has been determined as above. As the positive threshold, there is set for example a value of when a value of the F value using the number of evaluations determined for that scene becomes largest (for example see FIG. 10 and FIG. 11). In this embodiment, as shown in FIG. 20, a value [6] is set for the sunset scene, a value [7] is set for the flower scene, and [6] is set for the autumnal foliage scene.

The value [10] is determined as the number of evaluations in the sunset scene, and therefore when the evaluation results of only 10 partial images among the 64 partial images are used and the detected image number of the sunset scene detection number counter 71b exceeds the value [6], the sunset scene determining section 71c determines that the classification target image pertains to a sunset scene. And the value [20] is determined as the number of evaluations in the flower scene, and therefore when the evaluation results of only 20 partial images are used and the detected image number of the flower detection number counter 72b exceeds the value [7], the flower determining section 72c determines that the classification target image pertains to a flower scene. Since the positive thresholds are set for each specific scene in this manner, classification can be carried out suited to the respective scenes.

Regarding Negative Threshold

In determination of a scene that the classification target image pertains to, if a probability that it pertains to a certain scene is high, a probability that it pertains to another scene with different characteristics tends to be low. That is, with a certain partial sub classifier, it is possible to determine that the classification target image does not pertain to a scene (another scene) other than a scene corresponding to the classification target image, according to the number of partial images for each of which an evaluation result that the partial image is the scene to be targeted has been obtained. For example, in the case where a landscape scene and a sunset scene are compared, in the landscape scene, green and blue are predominant colors, whereas in the sunset scene, red is a predominant color. Therefore, in the image with red as the predominant color, it can be considered that a probability that it pertains to the sunset scene is high, and a probability that that it pertains to the landscape scene is low. From this, it can be understood that, according to evaluation results of partial images with each of the partial evaluation sections, the classification target image can be determined as not pertaining to another scene. Specifically, by evaluation with the partial evaluation sections, in the case where the number of partial images for each of which an evaluation result indicating that the partial image pertains to a scene corresponding to the partial sub classifier has been obtained has exceeded a negative threshold in respect to another scene, the determining section of each of the partial sub classifiers determines that the classification target image does not pertain to that scene. Therefore, according to the value of this negative threshold, the accuracy in determining that the classification target image does not pertain to another scene can be adjusted.

The negative threshold is provided based on, for example, an erroneous determination rate obtained using a plurality of sample images. It should be noted that, the erroneous determination rate is a probability that, in a case where a certain partial sub classifier handles a classification target image that pertains to another scene, the certain partial sub classifier mistakenly determines that the classification target image does not pertain to another scene. The erroneous determination rate is a ratio of, in the case where a certain partial sub classifier determines a plurality of sample images that pertain to another scene, the number of sample images determined as not another scene to the number of sample images targeted to be determined. Here, the determination that it does not pertain to another scene, is performed by comparing a provisional negative threshold that is set in advance (hereinafter referred to as provisional negative threshold) and the number of partial images classified as pertaining to a certain scene. That is, in the case where the number of partial images classified as pertaining to a certain scene exceeds the provisional negative threshold, the sample image is determined to not pertain to another scene. Then, by setting the provisional negative threshold for each of the number of partial images (detected image number) classified as pertaining to a certain scene, the erroneous determination rate is obtained for each detected image number.

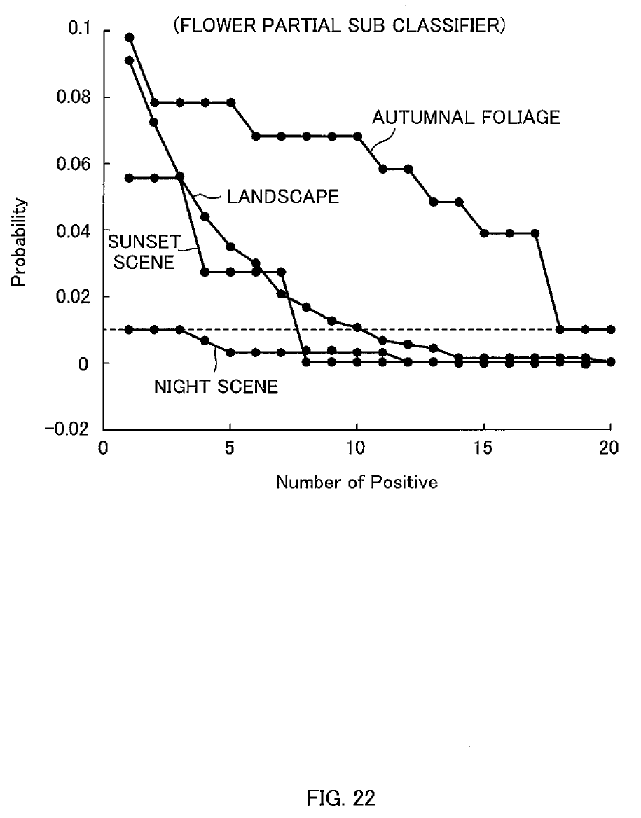

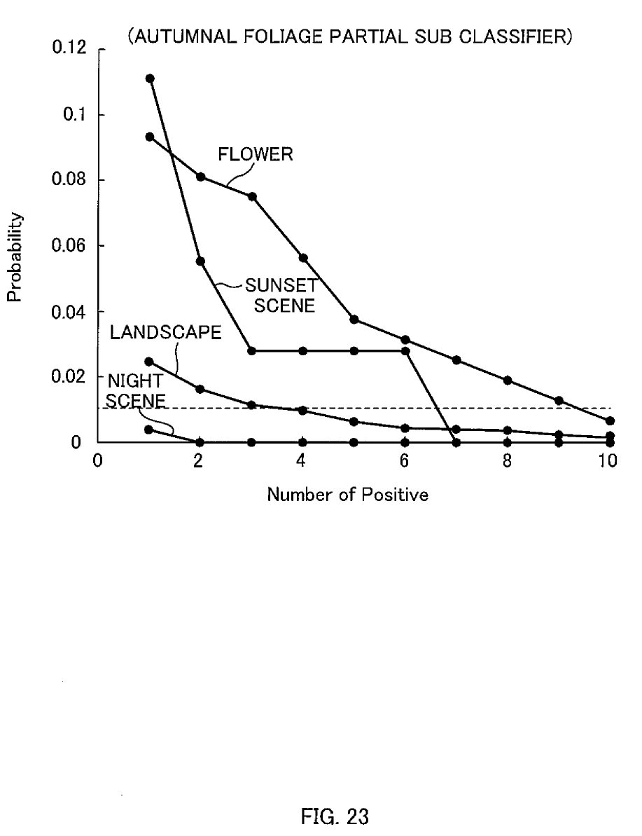

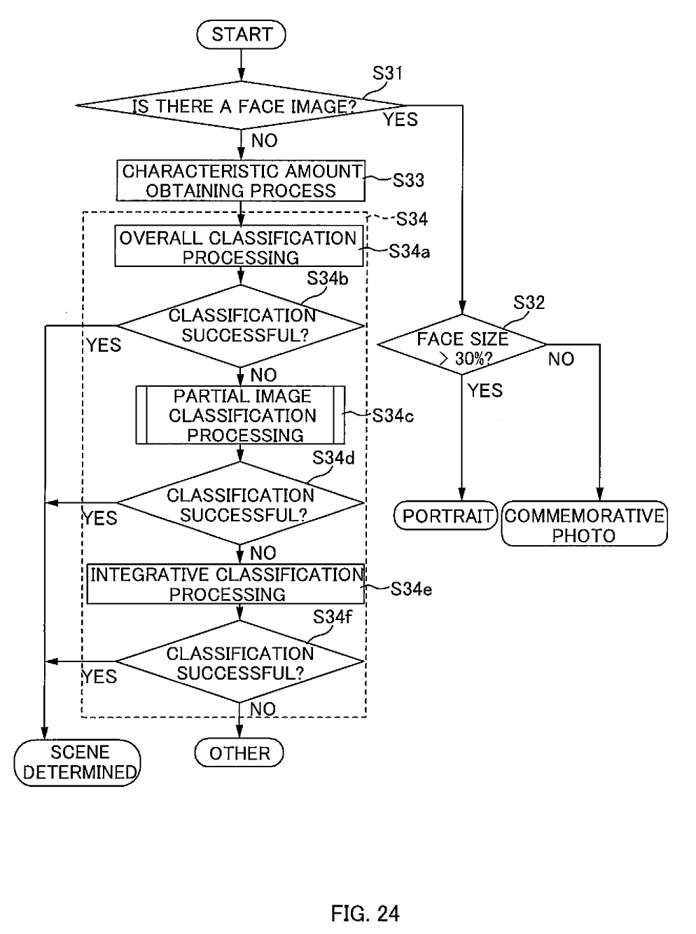

FIG. 21 is a diagram showing a relationship between detected image numbers (provisional negative thresholds) and erroneous determination rates with the sunset scene partial sub classifier 71. FIG. 22 is a diagram showing a relationship between detected image numbers (provisional negative thresholds) and erroneous determination rates with the flower partial sub classifier 72. Further, FIG. 23 is a diagram showing a relationship between detected image numbers (provisional negative thresholds) and erroneous determination rates with the autumnal foliage partial sub classifier 73.

The horizontal axis in each diagram shows the number of partial images (detected image number) for each of which an evaluation result indicating a corresponding scene has been obtained with each of the partial sub classifiers, and the vertical axis shows erroneous determination rates. It should be noted that, a largest value of the detected image number, is the number of evaluations determined in respect to each scene. For example, in the case of an erroneous determination rate of the sunset scene partial sub classifier 71 shown in FIG. 21, the largest value of the detected image number is a value [10] of the number of evaluations of the sunset scene, and in the case of erroneous determination rate of the flower sub classifier 72 shown in FIG. 22, the largest value of the detected image number is a value [20] of the number of evaluations of the flower scene.

As shown in FIG. 21, the erroneous determination rate of the flower scene, in the case where the detected image number (provisional negative values) is determined as a value [4], is a value [0.025]. The erroneous determination rate of [0.025] indicates that, in the case where the flower scene sample image is determined with the sunset scene partial sub classifier 71, under the conditions that the number of partial images (detected image number) detected as sunset scenes has become a value [4], when the sample image is determined as “not a flower scene”, the determination will be incorrect by a probability of 2.5%. In other words, it indicates that a flower scene sample image will be included by a probability of 2.5%.

In the classification processing of partial images, the larger the detected image number, the larger the probability that the classification target image is a scene corresponding to each of the partial sub classifiers. That is, as the detected image number becomes larger, it can be properly determined that the classification target image does not pertain to another scene. Therefore, as shown in FIG. 21, the larger the detected image number becomes, the smaller the erroneous determination rate in respect to other scenes. It is the same in the case of FIG. 22 and FIG. 23. The negative threshold is provided, based on the erroneous determination rate, for each of the classification target scenes other than the scene corresponding to each of the partial sub classifiers. In this embodiment, a smallest detected image number (provisional negative threshold) in the case where the erroneous determination rate becomes equal to or less than the value [0.01] is provided as a negative threshold. That is, in a certain partial sub classifier, the detected image number (the number of partial images for each of which an evaluation result indicating a corresponding scene is obtained), in the case where the probability that a certain partial sub classifier determines erroneously that the classification target image is not another scene is equal to or less than 1%, is set as a negative threshold. For example, in FIG. 21, in the case where the detected image number is [5], the erroneous determination rate of a night scene becomes less than a value [0.01]. Therefore, the negative threshold of the night scene in respect to the sunset scene partial sub classifier 71 is set as a value [5] (refer to FIG. 20). Further, for the autumnal foliage scene and the landscape scene, the detected image number is a value [1] and the erroneous determination rate is smaller than a value [0.01]. Therefore, the negative threshold of the autumnal scene and the landscape scene is set as a value [1]. Further, in FIG. 21, in the case where the detected image number in the flower scene is a value [10], the erroneous determination rate becomes larger than a value [0.01]. In this case, as shown in FIG. 23, the negative threshold in the flower scene is set as a value [10]. It should be noted that, the positive threshold of the sunset scene is a value [6], and in the case where the detected image number exceeds a value [6], the classification target image is specified as a sunset scene, and classification processing thereafter is not performed. Therefore this negative threshold ceases to actually function. By providing a negative threshold as described above, with the sunset scene sub classifier 71, in the case where the detected image number is larger than a value [1] and equal to or less than a value [5], the classification target image cannot be decided to pertain to a sunset scene, but it can be determined to not pertain to an autumnal foliage scene and a landscape scene. Further, in the case where the detected image number is a value [6], it cannot be decided that the classification target image pertains to a sunset scene, but it can be determined that it does not pertain to an autumnal foliage scene, a landscape scene, and a night scene.

Similarly for other partial sub classifiers, a smallest detected image number when the erroneous determination rate is smaller than a value [0.01] is provided as a negative threshold for each scene as shown in FIG. 22 and FIG. 23. For example, as shown in FIG. 20, for the flower partial sub classifier 72, a negative threshold of a landscape scene is set as a value [11], a negative threshold of a sunset scene is set as a value [8], a negative threshold of a night scene is set as a value [4], and a negative threshold of an autumnal foliage scene is set as a value [18]. Further, for the autumnal-foliage partial sub classifier 73, a negative threshold of a landscape scene is set as a value [4], a negative threshold of a sunset scene is set as a value [7], and a negative threshold of a night scene is set as a value [1], and a negative threshold of a flower scene is set as a value [10].

In this way, based on the erroneous determination rate, by providing the negative thresholds, a probability that the classification target image does not pertain to another scene can be adjusted, so that in the case where the possibility that the classification target image pertains to another scene is low, the classification processing of a corresponding partial sub classifier can be definitely omitted. At the time of obtaining an erroneous determination rate for each scene, a plurality of sample images with different compositions are used, so that a more accurate erroneous determination rate can be calculated. As a result an appropriate negative threshold can be provided for each scene. Further, by providing a negative threshold for each scene other than the scenes corresponding to each of the partial sub classifiers, with the classification processing of each of the partial sub classifiers, it can be determined, for a plurality of scenes, that the classification target image does not pertain to that scene. Therefore, determination regarding scenes that the classification target image does not pertain to can be efficiently performed.

With the partial image classifier 30G according to the present embodiment, first classification is carried out by the sunset scene partial sub classifier 71 with high priority. The partial support vector machine 71a for sunset scenes of the sunset scene partial sub classifier 71 obtains the classification function value based on partial characteristic amounts of the partial images selected based on the selection information. That is, it performs evaluations on the partial images. The sunset scene detection number counter 71b counts as its detected image number the classification results in which the classification function obtained by the partial support vector machine 71a for a sunset scene is correct. The sunset scene determining section 71c, in response to comparison between the detected image number of the sunset detection number counter 71b and the positive threshold, determines that the classification target image pertains to a sunset scene. In a case where the result here is that the classification target image could not be determined as pertaining to a sunset scene, the sunset scene determining section 71c, according to a comparison between the detected image number and the negative threshold, determines that the classification target image does not pertain to a scene other than the sunset scene.

In a case where the classification target image is not determined as pertaining to a sunset scene with the sunset scene determining section 71c, and is not determined as “pertaining to a flower scene”, the flower partial sub classifier 72, which is of a later stage, uses the partial support vector machine 72a for flowers and the flower detection number counter 72b to perform evaluation as to whether or not each of the partial images pertains to a flower scene. Then, the flower determining section 72c, according to the evaluation result, determines that the classification target image pertains to a flower scene, and that it does not pertain to scenes other than a flower scene.

Further still, in a case where the classification target image is not determined as pertaining to a flower scene, with the flower determining section 72c, and is not determined as “pertaining to an autumnal foliage scene”, the autumnal foliage partial sub classifier 73, which is of a later stage after the flower partial sub classifier 72, uses the partial support vector machine 73a for autumnal foliage and the autumnal foliage detection number counter 73b to perform evaluation as to whether or not each of the partial images pertains to an autumnal foliage scene. Then, the autumnal foliage determining section 73c, according to the evaluation result, determines that the classification target image pertains to an autumnal foliage scene, and that it does not pertain to scenes other than an autumnal foliage scene.

Regarding the Integrative Classifier 30H

As mentioned earlier, the integrative classifier 30H performs classification on scenes of classification target images for which no scene was established by the overall classifier 30F and the partial image classifier 30G respectively. The integrative classifier 30H according to the present embodiment performs classification on scenes based on probability information that has been determined by the overall sub classifiers (the support vector machines). Specifically, the integrative classifier 30H selectively reads out probability information of correct values from among the plurality of sets of probability information that have been stored in the probability information storing section 37f by the overall classifier 30F in overall classification processing. It then specifies probability information indicating the highest values from among the probability information that has been read out and sets the corresponding scene as the scene of the classification target image. By providing the integrative classifier 30H, an adequate scene can be classified even for classification target images in which a characteristic of a pertaining scene is not expressed to a great extent. That is, classification ability can be increased.

Regarding the Result Storing Section 37j

The result storing section 37j stores the classification results for the classification targets of the classification processing section 30I. For example, in a case where a positive flag has been stored in the positive flag storing section 37h based classification results of the overall classifier 30F or the partial image classifier 30G, the result storing section 37j stores that the classification target pertains to the scene corresponding to the positive flag. Suppose that in a case where a positive flag has been set indicating that the classification target image pertains to a landscape scene, the result storing section 37j stores result information that it pertains to a landscape scene. Similarly, in a case where a positive flag has been set indicating that the classification target image pertains to a sunset scene, the result storing section 37j stores result information that it pertains to a sunset scene. It should be noted in regard to all the scenes that result information is stored indicating that classification target images for which negative flags have been stored pertain to those other scenes. The classification results stored in the result storing section 37j are referenced in subsequent processing. In the multifunction machine 1, the result information is referenced by the image enhancement section 30C (see FIG. 3) and used in image enhancement. For example, contrast, brightness, color balance, and the like are adjusted in response to the classified scene.

Regarding Image Classification Processing

Next, description is given regarding image classification processing. In executing image classification processing, the printer-side controller 30 functions as the face detection section 30A and the scene classifier 30B (the characteristic amount obtaining section 30E, the overall classifier 30F, the partial image classifier 30G, the integrative classifier 30H, and the result storing section 37j). In this case, the CPU 36 of the main controller 31 executes the computer programs stored in the memory 37. Accordingly, image classification processing is described as a process of the main controller 31. And the computer programs executed by the main controller 31 are provided with code for achieving the image classification processing.

As shown in FIG. 24, the main controller 31 reads in the target image data and determines the presence/absence of a face image (S31). The presence/absence of a face image can be determined by various methods. For example, the main controller 31 can determine the presence/absence of a face image based on the presence/absence of areas of standard color skin colors and by the presence/absence of eye images and mouth images within such areas. In the present embodiment, face images equal to or larger than a fixed area (for example, equal to or more than 20×20 pixels) are set as detection targets. When it has been determined that there is a face image, the main controller 31 obtains a percentage of face image area within the classification target image, and determines whether or not this percentage exceeds a predetermined threshold (which is set to 30% for example) (S32). When it has exceeded 30%, the main controller 31 classifies the classification target image as a portrait scene (yes at S32). And when it does not exceed 30%, the main controller 31 classifies that the classification target image is a commemorative photo scene (no at S32). These classification results are stored in the result storing section 37j.

When there is no face image in the classification target image (no at S31), the main controller 31 carries out a characteristic amount obtaining process (S33). In the characteristic amount obtaining process, characteristic amounts are obtained based on the target image data. That is, overall characteristic amounts, which indicate overall characteristics of the classification target image, and partial characteristic amounts, which indicate partial characteristics of the classification target image, are obtained. It should be noted that description has already been given regarding obtaining these characteristic amounts (see S11 to S15 and FIG. 6), and therefore description is omitted here. Then, the main controller 31 stores the characteristic amounts that have been obtained in the characteristic amount storing section 37e of the memory 37.

After the characteristic amounts have been obtained, the main controller 31 carries out scene classification processing (S34). In this scene classification processing, the main controller 31 first functions as the overall classifier 30F and carries out overall classification processing (S34a). In the overall classification processing, classification is carried out based on overall characteristic amounts. Then, if a classification target image was able to be classified in the overall classification processing, the main controller 31 determines the scene of the classification target image as a classified scene (yes at S34b). For example, the main controller 31 determines the scene of the classification target image as a scene for which a positive flag is stored in the overall classification processing. And the classification result is stored in the result storing section 37j. If a scene is not determined in the overall classification processing, the main controller 31 functions as the partial image classifier 30G and carries out partial image classification processing (34c). In the partial image classification processing, classification is carried out based on partial characteristic amounts. And if a classification target image was able to be classified in the partial image classification processing, the main controller 31 determines the scene of the classification target image as a classified scene (yes at S34c) and stores the classification result in the result storing section 37j. It should be noted that details of partial image classification processing are described later. If the partial image classifier 30G also does not determine a scene, the main controller 31 functions as the integrative classifier 30H and carries out integrative classification processing (S34e). In this integrative classification processing, the main controller 31 reads out positive values among the probability information calculated during overall classification processing from the probability information storing section 37f as described earlier, and determines the scene of the classification target as the scene corresponding to the probability information having the largest value. Then, if a classification target image is able to be classified in the integrative classification processing, the main controller 31 determines the scene of the classification target image as a classified scene (yes at S34f). On the other hand, when classification of the classification target image cannot be achieved even with the integrative classification processing (when there are no positive values in the probability information calculated in the overall classification processing) and negative flags have been stored for all the scenes, the classification target image is classified as an “other” scene (no at S34f). It should be noted that in integrative processing, the main controller 31 as the integrative classifier 30H first determines whether negative flags have been stored for all the scenes. Then, in a case when it is determined that negative flags have been stored for all the scenes, it classifies the classification target image as being an “other” scene based on that determination. In this case, processing can be achieved merely by checking for negative flags, and therefore greater speeds in processing can be achieved.

Regarding Partial Image Classification Processing

Next, description is given regarding partial image classification processing. As mentioned earlier, partial image classification processing is carried out in a case where the classification target image could not be classified in overall classification processing. Accordingly, at the stage where partial image classification processing is to be carried out, positive flags are not stored in the positive flag storing section 37h. Furthermore, for scenes where it was determined in the overall classification processing that the classification target image was not pertaining to those scenes, a negative flag is stored in the corresponding area of the negative flag storing section 37i. Furthermore, stored in advance in the selection information storing section 37k for each of the specific scenes is one of either multiplication value information, which is a multiplication value in which the existence probability and partial precision obtained using a plurality of sample images are multiplied for each of the partial areas (see FIG. 14C, FIG. 15C, and FIG. 16C), or multiplication value ranking information, which indicates a ranking of multiplication values for the plurality of partial areas (see FIG. 14D, FIG. 15D, and FIG. 16D).

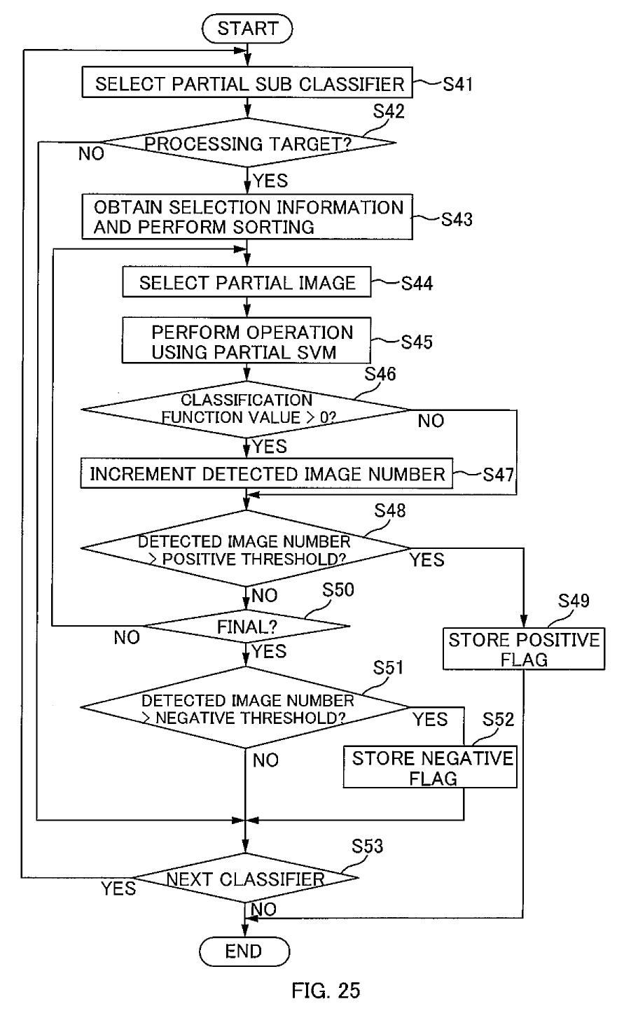

As shown in FIG. 25, the main controller 31 first selects the partial sub classifier for carrying out classification (S41). As shown in FIG. 5, in the partial image classifier 30G according to the present embodiment, priority is determined for the sunset scene partial sub classifier 71, the flower partial sub classifier 72, and the autumnal foliage partial sub classifier 73 in this order. Accordingly, the sunset scene partial sub classifier 71, which has the highest priority, is selected in a first time of the selection process. Then, when classification by the sunset scene partial sub classifier 71 is finished, the flower partial sub classifier 72, which has the second highest priority, is selected, and following the flower partial sub classifier 72, the autumnal foliage partial sub classifier 73 is selected, which has the lowest priority.

After the partial sub classifier has been selected, the main controller 31 determines whether the scene to be classified by the selected partial sub classifier is a target scene of classification processing (S42). This determination is carried out based on negative flags stored in the negative flag storing section 37i during overall classification processing by the overall classifier 30F and partial classification processing by the partial sub classifier. This is because when a positive flag is set by the overall classifier 30F, the scene is decided by overall classification processing and partial image classification processing is not carried out, and as is described later, when a positive flag is stored in the partial image processing, the scene is decided and classification processing finishes. In a case where the scene is not a target of classification processing, that is, a scene for which negative flag has been set during overall classification processing, and partial classification processing at an earlier stage, classification processing is skipped (no at S42). Thus there is no need to carry out unnecessary classification processing, and faster classification processing speeds can be achieved.

On the other hand, when it is determined at step S42 that it is a target for processing (yes at S42), the main controller 31 reads out selection information of the corresponding specific scene from the selection information storing section 37k (S43). Here, when the selection information obtained from the selection information storing section 37k is multiplication value information, the main controller 31 for example reorders (sorts) the values indicating the coordinates of the partial images while leaving the association with the value of the multiplication values as they are in order of highest multiplication values. On the other hand, when multiplication value ranking information is stored in the selection information storing section 37k, it performs a reordering in order of highest ranking information. Next, the main controller 31 carries out selection of partial images (S44). When the selection information is multiplication value information, the main controller 31 carries out selection in order from partial images corresponding to coordinates having the highest multiplication values. And when the selection information is multiplication value ranking information, it carries out selection in order from partial images corresponding to coordinates having the highest ranking. In this way, at step S44, partial images are selected corresponding to partial areas having the highest multiplication values of existence probability and partial precision among the partial images for which classification processing has not been carried out.

Then the main controller 31 reads out from the characteristic amount storing section 37e of the memory 37 the partial characteristic amounts corresponding to the partial image data of selected partial images. Operations are carried out by the partial support vector machines based on these partial characteristic amounts (S45). In other words, the obtaining of probability information corresponding to the partial images is carried out based on the partial characteristic amounts. It should be noted that in the present embodiment, not only the partial characteristic amounts but also the overall characteristic amounts are read out from the characteristic amount storing section 37e and calculations are carried out taking into account the overall characteristic amounts. At this time the main controller 31 functions as the partial evaluation section corresponding to the scene targeted for processing, and obtains the classification function values as probability information by performing calculations based on partial color average and partial color variance and the like. Then, main controller 31 carries out classification as to whether or not the partial image pertains to the specific scene according to the obtained classification function value (S46). Specifically, when the obtained classification function value for a certain partial image is a positive value, it is classified that the partial image pertains to the specific scene (yes at S46). Then, the count value of the corresponding detection number counter (detected image number) is incremented (+1) (S47). Furthermore, when the classification function value is not a positive value, it is classified that the partial image does not pertain to the specific scene and the count value of the detection number counter stays as it is (no at S46). By obtaining the classification function values in this manner, the classification of whether or not the partial image pertains to the specific scene can be carried out according to whether or not the classification function value is positive.

After the obtaining of probability information for the partial image and counter processing have been carried out, the main controller 31 functions as the determining sections and determines whether the detected image number is larger than the positive threshold (S48). In the case where the detected image number exceeds the positive threshold (yes in S48), a positive flag of the corresponding scene is stored in the flag storing section 37h (S49). For example, in a case where the positive thresholds stored in the parameter storing section 37b of the memory 37 are the values shown in FIG. 20, the sunset scene determining section 71c of the sunset scene partial sub classifier 71 determines that the classification target image is a sunset scene in the case where the detected image number exceeds the value [6], and stores a positive flag corresponding to the sunset scene in the positive flag storing section 37h. Furthermore, in a case where the detected image number exceeds the value [7], the flower determining section 72c of the flower partial sub classifier 72 determines that the classification target image is a flower scene and stores a positive flag corresponding to the flower scene in the positive flag storing section 37h. When a positive flag is stored, the process of classification finishes without carrying out the remaining classification processing.

When the detected image number does not exceed the positive threshold (no at S48), a determination is performed with the main controller at to whether the partial image that was evaluated was the final partial image of the number of evaluations determined for the scene (S50). For example, in the case of the sunset scene partial sub classifier 71, a determination is performed as to whether evaluation has finished for the 10 partial images that have been set as the number of evaluations. Here, when it is determined that it is not yet the final evaluation (no at S50), the procedure transitions to step S44 and the above-described processing is repeated. On the other hand, when it is determined at step S52 that it is the final evaluation (yes at S50), a determination is performed as to whether or not the detected image number exceeds a negative threshold provided for another scene (S51). For example, in the case of the sunset scene partial sub classifier 71, a determination is performed as to whether or not the detected image number exceeds negative thresholds of other scenes shown in FIG. 20 (a value [1] of the landscape scene, a value [5] of the night scene, a value [10] of the flower scene, and a value [1] of an autumnal foliage scene). As a result, in the case where the detected image number exceeds any of the negative thresholds (yes in S51), the negative flag corresponding to the scene is stored in the negative flag storing section 37i (S52).

On the other hand, in the case where it is determined at step S51 that the detected image number does not exceed any of the negative thresholds (no at S51), or when at step S42 it is not determined as a processing target (no at S42), or after the negative flag is stored in step S52, a determination is performed as to whether or not there is a next partial sub classifier (S53). Here the main controller 31 performs a determination as to whether processing has finished up until the autumnal foliage partial sub classifier 73, which has the lowest priority. Then, when processing until the autumnal foliage partial sub classifier 73 has finished, it is determined that there is no next classifier (no at S53) and the series of partial classification processing finishes. On the other hand, when it is determined that processing until the autumnal foliage partial sub classifier 73 has not finished (yes at 853), the partial sub classifier having the next highest priority is selected (S41) and the above-described processing is repeated. Here, in the case where the next partial sub classifier to be selected corresponds to a scene stored with a negative flag in step S52, in the next step S42, it is determined to not be a classification target in the determination as to whether or not it is a classification target (no at S42). Thus, the classification processing with the partial sub classifier can be omitted, and the speed of classification processing can be increased.

It should be noted that, in the above described embodiment, the detection number counter of each of the partial sub classifiers counts the number of partial images classified as pertaining to a specific scene, however, for example, the classification function value itself can be added (counted) using the detection number counter. Then, a positive threshold and a negative threshold can be respectively provided as the classification function, and a comparison between an added value of classification function values, and the positive threshold and the negative threshold can be performed with a corresponding determining section. In this case, the added value of the classification function values becomes the evaluation value obtained by evaluation of partial images with each of the partial sub classifiers.

### SUMMARY

Each of the partial sub classifiers of the partial image classifier 30G according to this embodiment is provided with the negative threshold for scenes other than its corresponding scene, and in the case where the detected image number detected with the partial sub classifier at an earlier stage exceeds the negative threshold, classification processing of a partial sub classifier at a later stage is omitted. This enables the speed of scene classification processing to be improved.

Further, the determining section of each of the partial sub classifiers determines that the classification target image pertains to its corresponding scene, in the case where the detected image number (the number of partial images obtained with evaluation results indicating that the partial images pertain to its corresponding scene) obtained with each detection number counter section exceeds the positive threshold, therefore classification accuracy in respect to its corresponding scene according to a value of the positive threshold can be adjusted.

The positive threshold is provided for each scene corresponding to each of the partial sub classifiers. In this way, classification appropriate for each of the scenes can be performed.

Further, the determining section of each of the partial sub classifiers determines that, in the case where the detected image number obtained with each detection number counter section exceeds a negative threshold different from the positive threshold, the classification target image does not pertain to the scene corresponding to the negative threshold. Thus, according to the value of the negative threshold, the accuracy in determining that the classification target image does not pertain to a scene corresponding to the negative threshold can be adjusted.

This negative threshold is provided, with a certain partial sub classifier, based on an erroneous determination rate that is a probability that the classification target image pertaining to another scene is determined erroneously as not pertaining to another scene. Thus, in the case where the possibility that the classification target image pertains to another scene is low, it is possible to definitely omit classification processing of another corresponding partial sub classifier.

Further, the negative threshold is provided for each classification target scene other than scenes corresponding to each of the partial sub classifiers. Thus, according to evaluation results of classification processing with each of the partial sub classifiers, determination of a scene that does not pertain to the classification target image can be efficiently performed.

Further, each of the partial sub classifiers evaluates only in respect to a part of partial images (partial images of the number of evaluations), and using the evaluation result, determines that the classification target image pertains to a corresponding scene, and that it does not pertain to scenes other than the scene corresponding to the classification target image. Thus, the speed of classification processing can be further improved.

And the number of evaluations is decided based on the precision and recall, which are benchmarks indicating the accuracy of classification processing by each of the determining sections. This enables an optimal number of evaluations to be decided for the specific scenes.

Furthermore, the partial images for which evaluation is to be carried out by each partial evaluation section are selected in order from the partial areas having highest multiplication values in which the existence probability and partial precision have been multiplied for each of the partial areas. In this way, evaluations are performed in order from partial areas in which characteristics of the targeted scene tend to be expressed and in which exact evaluations are obtained, and therefore the evaluations can be carried out efficiently.

It should be noted in regard to the classification of partial images that in the foregoing embodiment classification of partial images was carried out in order from partial areas having higher multiplication values of existence probability and partial precision based on the selection information stored in the selection information storing section 37k. By using this configuration, there is an advantage in that selection can be carried out with excellent efficiency from among the plurality of partial areas by applying a priority ranking for partial areas in which characteristics of the targeted scene tend to be expressed and in which exact evaluations are obtained. However, the method of selecting partial areas is not limited to this example. For example, the partial areas may be selected in order from those having either a higher existence probability or a higher partial precision. In these cases too, evaluations can be carried out with better efficiency than carrying out evaluations by selecting partial images randomly.

Further, with each of the partial sub classifiers, the erroneous determination rate is obtained using a plurality of sample images with different compositions, and the negative thresholds are set based on the erroneous determination rate. Thus, a more accurate erroneous determination rate can be obtained, so that an appropriate negative threshold can be provided for each scene.

### Other Embodiments

In the foregoing embodiment, the classification target was an image based on image data and the classification apparatus was the multifunction machine 1. Here a classification apparatus that has an image as a classification target is not limited to the multifunction machine 1. For example, it may be the digital still camera Dc, a scanner, or a computer that can execute an image processing computer program (retouching software for example). Furthermore, it may be an image display device that can display an image based on image data or an image data storage device that stores image data.

Furthermore, in the foregoing embodiment, description is given regarding the multifunction machine 1 that classifies scenes of classification target images, but also disclosed therein were: a scene classification apparatus, a scene classification method, a method using classified scenes (for example, image enhancement methods, printing methods, and liquid ejection methods based on scenes), computer programs, and storage media or the like on which computer programs and code are stored.

Furthermore, in regard to the classifiers, support vector machines were illustrated in the foregoing embodiment, but as long as this can recognize a scene of a classification target image, there is no limitation to support vector machines. For example, a neural network may be used or adaptive boosting may be used as classifiers.

Although the preferred embodiment of the invention has been described in detail, it should be understood that various changes, substitutions and alterations can be made therein without departing from spirit and scope of the inventions as defined by the appended claims.

What is claimed is:

1. A scene classification apparatus, comprising:
a first partial classifier that determines that a classification target image pertains to a first scene, according to an evaluation result indicating that a partial image pertains to the first scene, by carrying out an evaluation as to whether or not the partial image pertains to the first scene, based on a partial characteristic amount indicating a characteristic of the partial image that constitutes a part of the classification target image; and
a second partial classifier that determines that the classification target image pertains to a second scene having a characteristic different from that of the first scene, based on the partial characteristic amount, in the case where it is not determined that the classification target image pertains to the first scene with the first partial classifier;
wherein the first partial classifier determines that, in the case where it is not determined that the classification target image pertains to the first scene, according to an evaluation result indicating that the partial image pertains to the first scene, the classification target image does not pertain to the second scene.

2. A scene classification apparatus according to claim 1,
wherein the first partial classifier
determines that, in the case where an evaluation value, obtained by evaluating whether or not the partial image pertains to the first scene, exceeds a positive threshold, the classification target image pertains to the first scene.

3. A scene classification apparatus according to claim 2,
wherein the positive threshold is provided for each scene corresponding to each partial classifier.

4. A scene classification apparatus according to claim 2,
wherein the first partial classifier
determines that, in the case where the evaluation value exceeds a negative threshold different from the positive threshold, the classification target image does not pertain to the second scene.

5. A scene classification apparatus according to claim 4,
wherein the negative threshold
is provided based on an erroneous determination rate that is a probability that the classification target image pertaining to the second scene is mistakenly determined as not pertaining to the second scene with the first partial classifier.

6. A scene classification apparatus according to claim 4,
wherein the negative threshold
is provided for each scene that is a classification target other than scenes corresponding to each partial classifier.

7. A scene classification apparatus according to claim 2,
wherein the evaluation value
is the number of the partial images for each of which an evaluation result, indicating that the partial image pertains to the first scene has been obtained.

8. A scene classification apparatus according to claim 1,
wherein the first partial classifier
determines that the classification target image pertains to the first scene and that the classification target image does not pertain to the second scene, by using an evaluation result of only a predetermined number of the partial images selected from a part of the plurality of partial images that constitute the classification target image.

9. A scene classification apparatus according to claim 8,
wherein the predetermined number is determined based on
a precision that is a probability that, in the case where it has been determined that the classification target image pertains to the first scene with the first partial classifier, the determination thereof is correct, and
a recall that is a probability that the classification target image pertaining to the first scene is to be determined with the first partial classifier to pertain to the first scene.

10. A scene classification apparatus according to claim 8,
wherein the predetermined number of the partial images has been selected based on at least one of
an existence probability that is a probability that a characteristic of the first scene is expressed in a partial area corresponding to the partial image, and
a partial precision that is a probability that, in the case where an evaluation result indicating that the partial image pertains to the first scene has been obtained, the evaluation result thereof is correct.

11. A scene classification method comprising:
determining that a classification target image pertains to a first scene, according to an evaluation result indicating that a partial image pertains to the first scene, by carrying out an evaluation as to whether or not the partial image pertains to the first scene, based on a partial characteristic amount indicating a characteristic of the partial image that constitutes a part of the classification target image; and
determining that the classification target image does not pertain to the second scene, according to an evaluation result indicating that the partial image pertains to the first scene,
before a determination, in the case where it is not determined that the classification target image pertains to the first scene, as to whether or not the classification target image pertains to a second scene having a characteristic different from that of the first scene, the determination being performed according to an evaluation result indicating that the partial image pertains to the second scene.

12. A scene classification method according to claim 11, comprising:
detecting the number of the partial images for each of which an evaluation result, indicating that the partial image pertains to the first scene, has been obtained;
determining that the classification target image pertains to the first scene, in the case where the number of the partial images for each of which an evaluation result, indicating that the partial image pertains to the first scene, has been obtained has exceeded a predetermined threshold; and
determining that the classification target image does not pertain to the second scene, in the case where the number of the partial images for each of which an evaluation result indicating that the partial image pertains to the first scene has been obtained exceeds a negative threshold different from the positive threshold.

13. A scene classification method according to claim 12, comprising:
obtaining, using a plurality of sample images, an erroneous determination rate that is a probability that a classification target image pertaining to the second scene is to be determined as not pertaining to the second scene with the first partial classifier, for each of the number of the partial images for each of which an evaluation result, indicating that the partial image pertains to the first scene, has been obtained; and
providing the negative threshold based on the erroneous determination rate.
